(19) United States
(12) Patent Application Publication
(10) Pub. No.: US 2021/0027268 A1
(43) Pub. Date: Jan. 28, 2021

(54) COMMODITY SALES DATA PROCESSING APPARATUS AND COMMODITY SALES DATA PROCESSING METHOD

(71) Applicant: TOSHIBA TEC KABUSHIKI KAISHA, Tokyo (JP)

(72) Inventors: Yasuhiro Arai, Mishima (JP); Kuniyoshi Yamada, Tokyo (JP); Keiichi Hasegawa, Tokyo (JP); Tsuyoshi Gotanda, Tokyo (JP)

(21) Appl. No.: 17/068,870

(22) Filed: Oct. 13, 2020

Related U.S. Application Data
(63) Continuation of application No. 15/936,633, filed on Mar. 27, 2018.
Application No. 15/936,633 is a continuation of application No. 14/468,466, filed on Aug. 26, 2014, now abandoned.

(30) Foreign Application Priority Data
Sep. 6, 2013 (JP) 2013-185549

(51) Int. Cl. G06Q 20/20; G06Q 20/04

(52) U.S. Cl. CPC G06Q 20/209; G06Q 20/047

(57) ABSTRACT

An electric receipt system includes a point-of-sales terminal that generates electric receipt data; and an electric receipt management server that sends the electric receipt data to a portable terminal. The point-of-sales terminal includes a memory, and a processor configured to generate, in response to input of a commodity code for a commodity to return after sending the electric receipt data, corrected electric receipt data containing commodities included in the electric receipt data except for a commodity with the commodity code, send the corrected electric receipt data, and generate, in response to input of a commodity code after sending the electric receipt data, returned-commodity receipt data according to the commodity code, and a printer that prints a return receipt based on the returned-commodity receipt data. The electric receipt management server includes a memory and a processor configured to receive and send the corrected electric receipt data to the portable terminal.

### CROSS-REFERENCE TO RELATED APPLICATIONS

This application is a Continuation of application Ser. No. 15/936,633 filed on Mar. 27, 2018, which is a Continuation of application Ser. No. 14/468,466 filed on Aug. 26, 2014, now abandoned, the entire contents of both of which are incorporated herein by reference.

This application is based upon and claims the benefit of priority from Japanese Patent Application No. 2013-185549, filed Sep. 6, 2013, the entire contents of which are incorporated herein by reference.

### FIELD

Embodiment described herein related to a commodity sales data processing apparatus and a commodity sales data processing method

### BACKGROUND

Conventionally, there is known a mechanism which prints receipt data containing commodity sales data of a commodity purchased from a store on a receipt handed to a customer, or sends the receipt data as electronic receipt data to be electronically transmitted to a portable terminal and the like of a customer at the time of commodity settlement in a POS terminal.

The receipt data is converted into electronic receipt data as stated above, thus, bookkeeping can be carried out in a household account book automatically and electronically, which is beneficial to the customer. Further, the electronic receipt data is received by a portable terminal and the like, and therefore, the consumption amount of receipt paper can be reduced, which is beneficial to the introduction store.

However, it is set in the conventional technology that the receipt data sent to the customer as electronic receipt data is not printed by a printing section of the POS terminal and the like. As a result, the changed receipt data, even if being sent to the customer as electronic receipt data, is not printed by the printing section, which leads to a problem that a changed store reservation-oriented receipt cannot be issued.

### BRIEF DESCRIPTION OF THE DRAWINGS

FIG. 1 is a constitution diagram illustrating the whole constitution of an electronic receipt system according to one embodiment;

FIG. 2 is a transition diagram illustrating a transition example of a screen in a member registration of a customer;

FIG. 3 is a block diagram illustrating the constitution of main portions of a POS terminal;

FIG. 4 is a block diagram illustrating the constitution of main portions of an electronic receipt server;

FIG. 5 is a block diagram illustrating the constitution of main portions of an electronic receipt management server;

FIG. 6 is a memory map illustrating part of an electronic receipt management area of the electronic receipt management server;

FIG. 7 is a block diagram illustrating the constitution of main portions of a portable terminal;

FIG. 8 is a functional block diagram relating to an electronic receipt processing in the POS terminal;

FIG. 9 is a diagram schematically illustrating one example of receipt data;

FIG. 10 is a diagram schematically illustrating one example of electronic receipt

FIG. 11 is a flowchart illustrating a flow of electronic receipt processing in the POS terminal;

FIG. 12 is a flowchart illustrating a flow of receipt processing carried out when a uniform cancel key is operated in the POS terminal;

FIG. 13 is a flowchart illustrating a flow of receipt processing carried out when a reissuing key is operated in the POS terminal;

FIG. 14 is a flowchart illustrating a flow of receipt processing carried out when a commodity return key is operated in the POS terminal;

FIG. 15 is a diagram schematically illustrating one example of new electronic receipt generated after the commodity return processing;

FIG. 16 is a flowchart illustrating a flow of receipt processing carried out when a register minus key is operated in the POS terminal;

FIG. 17 is a flowchart illustrating a flow of receipt processing carried out when a partial cancel key is operated in the POS terminal;

FIG. 18 is a flowchart illustrating a flow of electronic receipt management processing and information sending processing in the electronic receipt server;

FIG. 19 is a functional block diagram relating to electronic receipt management processing and commodity information sending processing in the electronic receipt management server;

FIG. 20 is a flowchart illustrating a flow of the electronic receipt management processing and the commodity information sending processing in the electronic receipt management server;

FIG. 21 is a flowchart illustrating a flow of the electronic receipt management processing and the commodity information sending processing in the electronic receipt management server;

FIG. 22 is a flowchart illustrating a flow of the electronic receipt management processing and the commodity information sending processing in the electronic receipt management server;

FIG. 23 is a flowchart illustrating a flow of the electronic receipt management processing and the commodity information sending processing in the electronic receipt management server;

FIG. 24 is a functional block diagram relating to electronic receipt reception processing and electronic receipt browsing processing in the portable terminal;

FIG. 25 is a flowchart illustrating a flow of the electronic receipt reception processing and the electronic receipt browsing processing in the portable terminal; and

FIG. 26 is a diagram illustrating one example of an electronic receipt displayed on a display section of the portable terminal.

### DETAILED DESCRIPTION

In accordance with one embodiment, a commodity sales data processing apparatus comprises an electronic receipt data sending module configured to generate electronic receipt data from receipt data generated based on transaction information of commodities subjected to settlement processing and send the generated electronic receipt data to an external device; a change receipt data generation module configured to generate new change receipt data according to the change of the transaction information; and a control module configured to generate, in a case in which the change receipt data generated by the change receipt data generation module contains customer specification information for specifying a customer, change electronic receipt data from the change receipt data and send the generated change electronic receipt data to the external device, and output printing data based on the change electronic receipt data to a printing section.

In accordance with one embodiment, a commodity sales data processing method includes generating electronic receipt data from receipt data generated based on transaction information of commodities subjected to settlement processing and sending the generated electronic receipt data to an external device; generating new change receipt data according to the change of the transaction information; and generating, in a case in which the change receipt data generated by the change receipt data generation module contains customer specification information for specifying a customer, change electronic receipt data from the change receipt data and sending the generated change electronic receipt data to the external device, and outputting printing data based on the change electronic receipt data to a printing section.

One embodiment is described below with reference to the accompanying drawings.

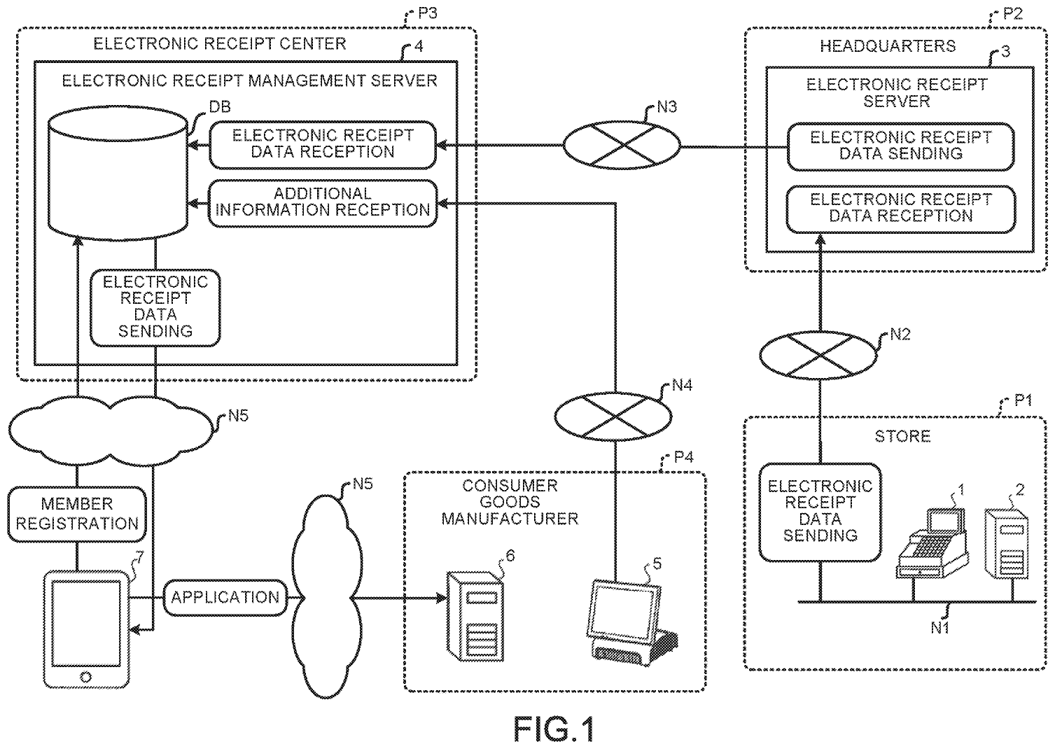

FIG. 1 is a constitution diagram illustrating the whole constitution of an electronic receipt system according to the embodiment. As shown in FIG. 1, the electronic receipt system includes a POS (Point of Sales) terminal 1, a store server 2, an electronic receipt server 3, an electronic receipt management server 4, a promotion setting terminal 5, a promotion management server 6 and a portable terminal 7.

The POS terminal 1 and the store server 2 are arranged in a store P1. The POS terminal 1 and the store server 2 are connected to be capable of communicating with each other through an in-store network N1 such as a LAN (Local Area Network) and the like. The POS terminal 1 and the store server 2 can be connected, through a network device (not shown) such as a router connected with the in-store network N1, with a network N2 which connects the store P1 with headquarters P2. The network N2 is, for example, a dedicated line such as an internet or a VPN (Virtual Private Network) and the like.

The POS terminal 1 is a commodity sales data processing apparatus for executing commodity sales data processing. The POS terminal 1 generates receipt data containing transaction content of commodities to be subjected to settlement processing, and outputs a paper receipt after printing the generated receipt data on paper through a later-described printing section 13. The POS terminal 1 further outputs (sends) electronic receipt data obtained by converting the data form of the receipt data to the electronic receipt server 3 through the network N2. No specific limitation is given to the method of sending the electronic receipt data, and the electronic receipt data may be sent using a general protocol such as an HTTP or an HTTPS and the like. In addition, no specific limitation is given to the number of the POS terminals 1 arranged in the store P1, and a plurality of POS terminals 1 may be arranged.

The store server 2 uniformly manages the commodity sales data processing and the like carried out by the POS terminal 1. For example, the store server 2 stores and manages the commodity sales data generated in the commodity sales data processing of the POS terminal 1 and commodity data files and the like used in the commodity sales data processing.

The number of the POS terminals 1 arranged in the store P1, which is not limited, may be more than one. Though it is exemplified in the present embodiment that the POS terminal 1 outputs the electronic receipt data, the present invention is not limited to this, and it is also applicable that the data form of the receipt data generated by the POS terminal 1 is converted by the store server 2 or a conversion device (not shown) and then the obtained electronic receipt data is output to the electronic receipt server 3.

The electronic receipt server 3, which is arranged in the headquarters P2 of a company that runs the store or chain store (hereinafter, referred to as store), functions as a receipt management server for company for managing the receipt data for each company running a store. The electronic receipt server 3 has functions such as sales management, sales analysis and stock management of a company running a store.

The electronic receipt server 3 receives, through the network N2, the electronic receipt data sent from the POS terminal 1. The electronic receipt server 3 sends the received electronic receipt data to the electronic receipt management server 4 through a network N3 that connects the headquarters P2 with an electronic receipt center P3.

The network N3 is, for example, a dedicated line such as the Internet or a VPN and the like. No specific limitation is given to the method of sending the electronic receipt data, and the electronic receipt data may be sent using a general protocol such as an HTTP or an HTTPS.

The electronic receipt management server 4 is arranged in the electronic receipt center P3. The electronic receipt center P3 is, for example, a third party organization other than the company which manages the receipt data through the electronic receipt server 3. The electronic receipt server 3 may also be managed by the third party organization and the like.

The electronic receipt management server 4 functions as a receipt management server for customer for collectively managing the receipt data of various companies running a store. The electronic receipt management server 4 stores and manages, in a member master held in a database DB, member data such as the full name and a member code serving as a customer code of each customer (member) who carried out member registration through a later-described procedure, and transmission destination information (for example, mail address) of the portable terminal 7 serving as the transmission destination of the electronic receipt data. Further, a member management server and the like may be arranged separately from the electronic receipt management server 4 to store and manage the member data.

The electronic receipt management server 4 receives, through the network N3, the electronic receipt data sent from the electronic receipt server 3, and stores and manages the electronic receipt data in a later-described electronic receipt management area 43a held in the database DB. More specifically, the electronic receipt data, which includes elements such as member code in addition to the commodity transaction content (commodity sales data), is managed in association with the member data of the corresponding member.

The electronic receipt management server 4 receives additional information such as campaign information relating to a campaign of a specific commodity from the promotion setting terminal 5 which is connected with the electronic receipt management server 4 through a later-described network N4, and stores and manages the additional information in a later-described additional information management area 43b held in the database DB. More specifically, the additional information is managed in association with the element corresponding to a specific condition in the elements contained in the electronic receipt data stored in the database DB.

If the electronic receipt data is stored in the database DB, the electronic receipt management server 4 specifies the transmission destination (portable terminal 7) by reference to the transmission destination information associated with the member code of the electronic receipt data. Then the electronic receipt management server 4 sends the electronic receipt data stored in the database DB to the specified transmission destination through a later-described network N5. In a case in which additional information is associated with the electronic receipt data, the additional information is also sent to the transmission destination together with the electronic receipt data.

If an electronic receipt inquiry in which the member code is designated is received from the portable terminal 7 connected with the electronic receipt management server 4 through a later-described network N5, the electronic receipt management server 4 extracts the electronic receipt data corresponding to the member code from the database DB and sends the extracted electronic receipt data to the portable terminal 7. In a case in which additional information is associated with the electronic receipt data, the additional information is also sent to the portable terminal 7 which sent the inquiry.

The promotion setting terminal 5 and the promotion management server 6 are arranged in a consumer goods manufacturer P4 and the like. The promotion setting terminal 5, which is a terminal device such as a PC (Personal Computer) and the like, sends additional information to the electronic receipt management server 4 through the network N4. The network N4 is, for example, a dedicated line such as the Internet or a VPN and the like. No specific limitation is given to the method of sending the additional information, and the additional information may be sent using a general protocol such as an HTTP or an HTTPS and the like.

The portable terminal 7 is a terminal device such as a smart phone, a mobile phone, a PDA (Personal Digital Assistant), a tablet computer and the like used by the user (customer) of the present system. The portable terminal 7 is equipped with an application such as a Web browser for browsing various kinds of information provided on the network N5. Moreover, a terminal device such as a PC and the like can be used instead of the portable terminal 7.

The portable terminal 7 accesses the electronic receipt management server 4 through the network N5 to carry out member registration to the present system. The network N5 is the Internet or various public networks.

Incidentally, the member registration of the customer in the present system is carried out according to, for example, the following procedure. The customer sends a blank mail from the portable terminal 7 to the electronic receipt management server 4 through the network N5. The electronic receipt management server 4 sends a URL (Uniform Resource Locator) indicating the page for member registration to the received mail address. The customer accesses the URL indicating the page for member registration from the portable terminal 7 and an input screen for inputting information (full name, transmission destination information and the like) required to carryout the member registration is displayed. After the customer completes the inputting of the necessary information, the electronic receipt management server 4 executes member registration for the member master. Sequentially, the electronic receipt management server 4 sends a member registration completion mail containing the member code (customer code) and a pass word to the portable terminal 7. In this way, the member registration is completed.

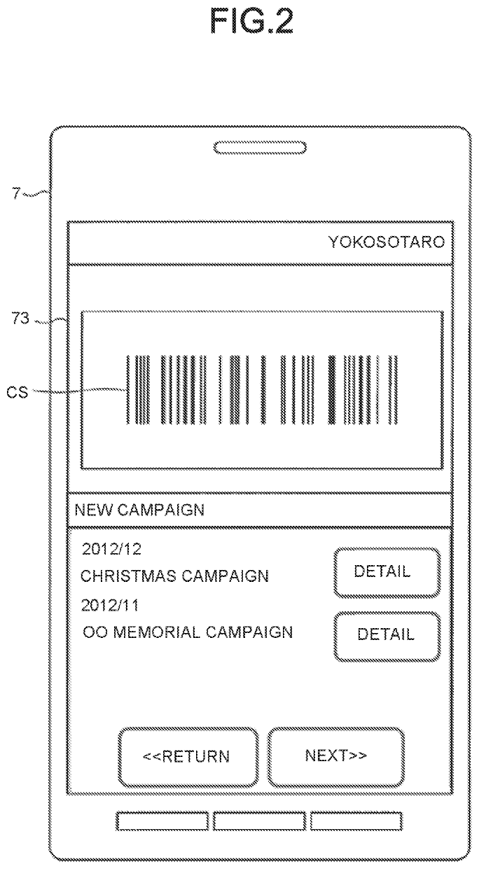

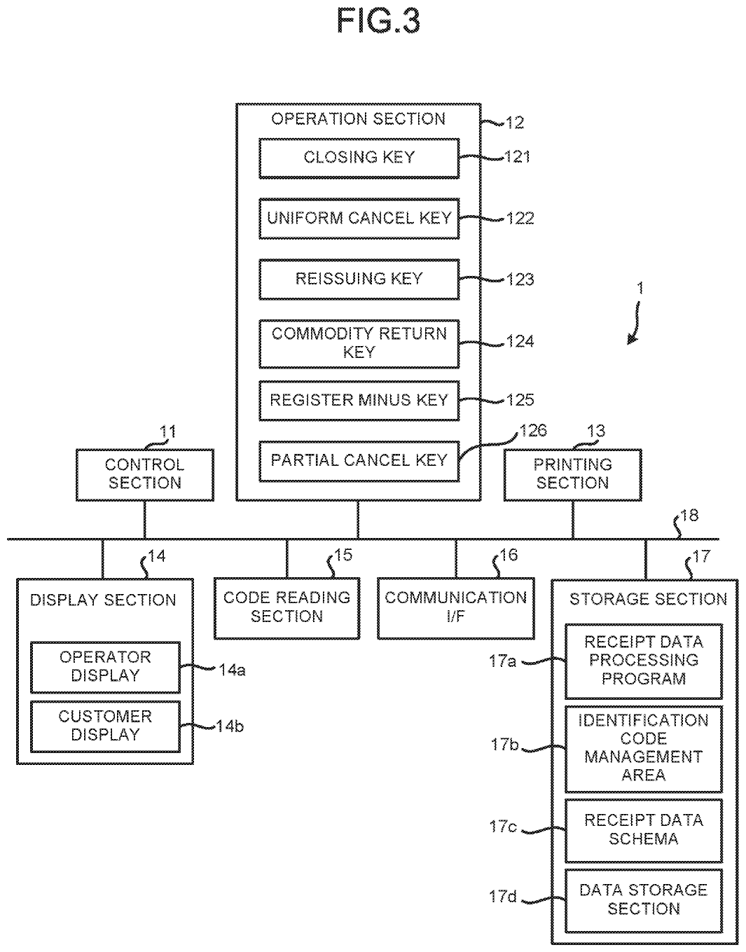

After the member registration stated above, as shown in FIG. 2, the portable terminal 7 displays the member code of the customer on a display section 73 as a code symbol CS such as a barcode or a two-dimensional code and the like. The customer presents the code symbol CS displayed on the portable terminal 7 to a shop clerk at the time of transaction settlement in the store P1. The shop clerk reads the code symbol CS displayed on the portable terminal 7 through a code reading section 15 (refer to FIG. 3) including, for example, a scanner connected with the POS terminal 1. In this way, the member code of the customer can be associated with the receipt data generated after the settlement based on the commodity sales data processing in the POS terminal 1.

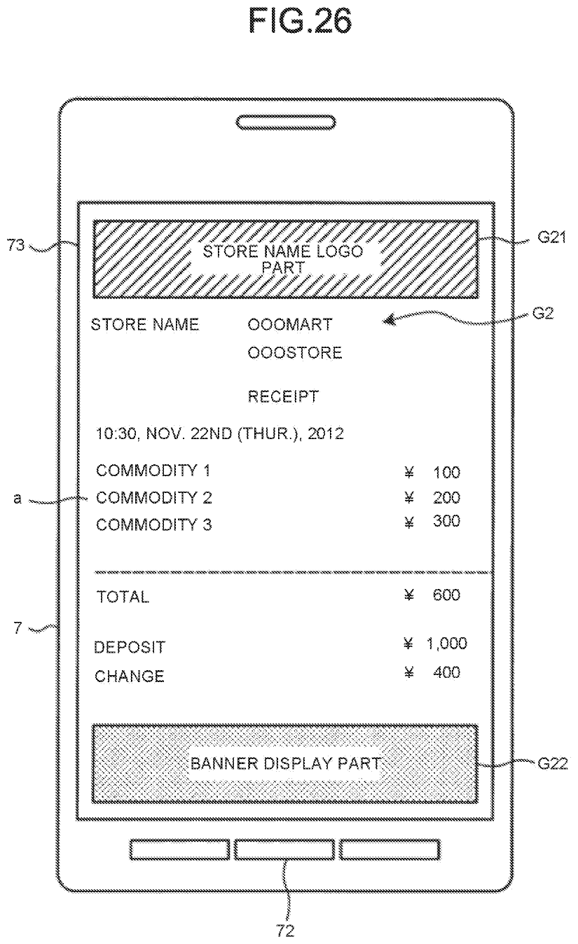

The portable terminal 7 receives, through the network N5, the electronic receipt data of the transaction sent from the electronic receipt management server 4 after the settlement (transaction) carried out in the POS terminal 1. The portable terminal 7 sends an electronic receipt inquiry in which the member code is designated to the electronic receipt management server 4 through the network N5, and then receives the electronic receipt data of the corresponding member from the electronic receipt management server 4. Then the portable terminal 7 displays the received electronic receipt data on the later-described display section 73 (refer to FIG. 26).

In a case in which additional information is associated with the received electronic receipt data, the portable terminal 7 displays, for example, an icon (refer to FIG. 26) for instructing an application for a planning relating to a campaign based on the additional information. For example, connection destination information (URL and the like) indicating an application destination (for example, the promotion management server 6) for the planning can be set in the icon. In this case, if the operation on the icon is received, the portable terminal 7 accesses the promotion management server 6 through the network N5 to execute processing relating to the application.

The promotion management server 6 is a server device for receiving access from the portable terminal 7 which is connected with the promotion management server 6 through the network N5. The promotion management server 6 is provided with an entry master for managing application history of each category of campaign in association with the member code for identifying each member. If the application for a campaign is received from the portable terminal 7 through the network N5, the promotion management server 6 manages the application history of each category of campaign in association with the member code. When accessing the promotion management server 6, the portable terminal 7 sends a member code relating to a user (member) of its own device held in the receipt data and the like.

In the electronic receipt system having such a constitution, the electronic receipt data (receipt data) indicating the content of the transaction (settlement) generated in the commodity sales data processing carried out in the POS terminal 1 of the store P1 is transmitted to the electronic receipt management server 4 through the electronic receipt server 3 and disclosed on the Web. Thus, the portable terminal 7 equipped with a Web browser can designate the URL (Uniform Resource Locator) to download the receipt data disclosed on the Web to the portable terminal 7 and browse the receipt data through the Web browser. Further, an application for browsing the receipt data may be installed in the portable terminal 7 to browse the receipt data.

Next, the constitution of main devices constituting the electronic receipt system of the present embodiment is described.

First, the POS terminal 1 serving as the commodity sales data processing apparatus is described. FIG. 3 is a block diagram illustrating the constitution of the POS terminal 1. As shown in FIG. 3, the POS terminal 1 includes a control section 11 for controlling various operations and each section of the POS terminal 1 uniformly. The control section 11 is a computer including a CPU (Central Processing Unit), a ROM (Read Only Memory) for storing various programs and data, a RAM (Random Access Memory) for storing various programs temporarily and overwriting various data freely, and an RTC (Real Time Clock) section for counting the current date and time, and the like.

The control section 11 is connected with an operation section 12, the printing section 13, a display section 14 and the code reading section 15 through a bus line 18.

The operation section 12 includes various operation keys for an operator to carry out an input operation. The operation keys include, for example, numeric keys for inputting numeric, a cursor key and a selection determination key for selecting a given item, a subtotal key instructing the total output of the commodity to be subjected to the sales registration in the transaction, a closing key for declaring to carry out closing processing of one transaction and settle the payment, and the like.

The operation section 12 includes a keyboard on which keys such as a closing key 121, a uniform cancel key 122, a reissuing key 123, a commodity return key 124, a register minus key 125 and a partial cancel key 126 are arranged. The closing key 121 is operated in a case of desiring to end the transaction with the customer. The uniform cancel key 122 is operated in a case of desiring to stop the transaction during the operation. The reissuing key 123 is operated in a case of desiring to reissue a receipt on which the commodity information and the settlement information of the transaction are printed after the transaction is ended. The commodity return key 124 is operated in a case of desiring to return all or part of the purchased commodities after the transaction is ended. The register minus key 125 is operated in a case of desiring to cancel, in a case in which there is an input error due to an incorrect operation and the like, the transaction after the transaction is ended. The partial cancel key 126 is operated in a case of desiring to cancel part of commodities after the transaction is ended.

The printing section 13 consists of a printer device for printing on a receipt or a journal and the like. The printing section 13 further includes a cutting mechanism (not shown) for cutting paper such as roll paper serving as printing target, and cuts the paper according to a later-described cutting command.

The display section 14, which is, for example, a liquid crystal display, displays various kinds of information such as the name and price of the commodity subjected to sales registration, and total amount, change amount and the like of one transaction the settlement of which is declared. The display section 14 includes an operator display 14a for displaying various kinds of information to a cashier and a customer display 14b for displaying various kinds of information to a customer. The display section 14 may be a touch panel, and in this case, the touch panel functions as the operation section 12.

The code reading section 15 is a scanner device for optically reading a code symbol such as a barcode or a two-dimensional code and the like. The code reading section 15 reads, for example, the code symbol attached to a commodity or the code symbol displayed on the portable terminal 7, and the control section 11 inputs the information contained in the read code symbol. The code symbol attached to the commodity is made to contain a commodity code for specifying the commodity, and the like. The code symbol displayed on the portable terminal 7 is made to contain a member code (customer code) for specifying the customer who carries the portable terminal 7, and the like. The member code may also be stored in the portable terminal 7 in a magnetic or electrical manner. In this case, the stored member code is read by a dedicated reading device. The control section 11 inputs the read member code.

The control section 11 connected with a communication I/F (interface) 16 through the bus line 18 can be connected with the in-store network N1 and the network N2 through the communication I/F 16.

The control section 11 is connected with a storage section 17 through the bus line 18. The storage section 17 is an auxiliary storage device such as an HDD (Hard Disk Drive) or a SSD (Solid State Drive) and the like. The storage section 17 stores programs for executing various POS jobs including the commodity sales data processing. The storage section 17 further stores various data files relating to commodity sales data processing, such as a commodity data file in which commodity data such as a commodity name, a commodity code and a unit price and the like of each commodity is stored. The storage section 17 stores a receipt data processing program 17a for carrying out commodity sales data processing and processing relating to receipt data.

The storage section 17 stores a POS number for identifying the POS terminal 1 of its own from other POS terminals 1, a company code (identification code of a company running a store), a business type/business style code, a store code indicating the store P1 in which the POS terminal 1 is arranged, and the like in an identification code management area 17b. The business type/business style code is a code (classification code) for distinguishing the business type/business style (for example, a convenience store, a supermarket, a department store, a pharmacy, a restaurant and an eating house) of the store. Such a business type/business style can be changed freely according to the preference of a user. The company code (identification code of a company running a store) and the business type/business style code may also be registered in the electronic receipt server 3.

The storage section 17 further stores a receipt data schema 17c for describing conversion rules used when converting unstructured receipt data into structured receipt data (hereinafter, referred to as electronic receipt data). The storage section 17 stores the commodity sales data subjected to commodity sales data processing and the read member code in a data storage section 17d.

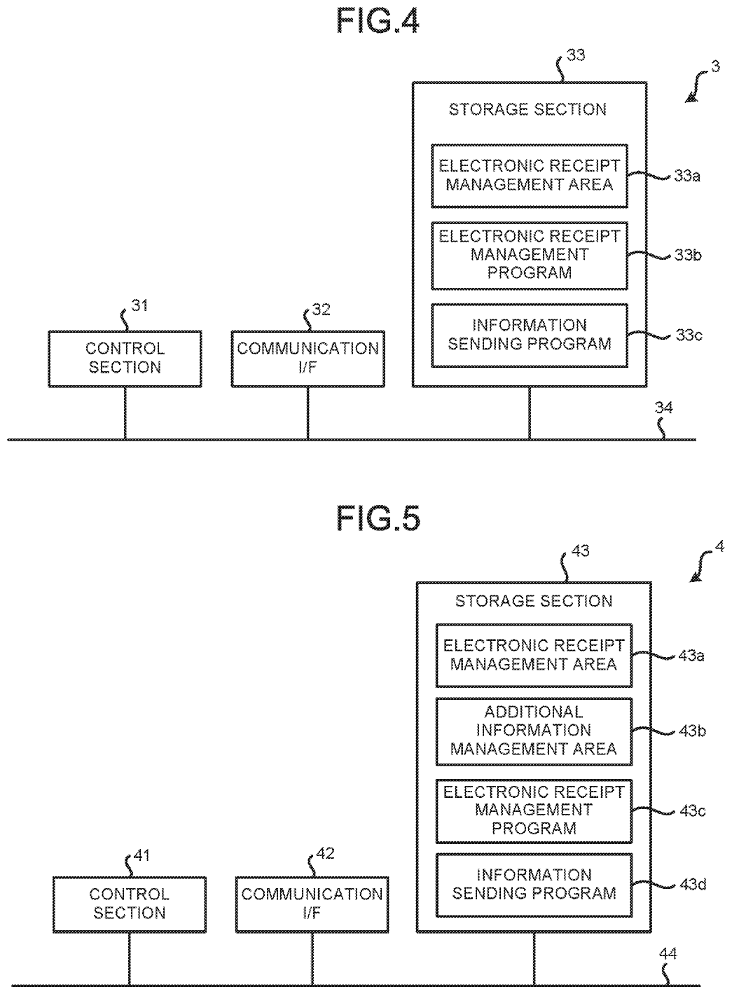

Next, the constitution of the electronic receipt server 3 functioning as a receipt management server for company is described with reference to the block diagram shown in FIG. 4. The electronic receipt server 3 includes a control section 31 for controlling various operations and each section of the electronic receipt server 3 uniformly. The control section 31 is a computer including a CPU, a ROM for storing various programs and data, a RAM for storing various programs temporarily and overwriting various data freely, and an RTC section for counting the current date and time, and the like.

The control section 31 can be connected with the network N2 and the network N3 through a communication I/F 32 connected with a bus line 34. The control section 31 is connected with a storage section 33 through the bus line 34.

The storage section 33 stores the electronic receipt data for each company running a store in an electronic receipt management area 33a. The electronic receipt data contains a company code (identification code of a company running a store), a business type/business style code, a store code, a member code of a customer, a POS number of a POS terminal 1, a receipt number, commodity sales data and the like.

The storage section 33 further stores an electronic receipt management program 33b for the management of the electronic receipt data by the electronic receipt management area 33a. The storage section 33 stores an information sending program 33c for sending the receipt data managed by the electronic receipt management area 33a to the electronic receipt management server 4.

Next, the constitution of the electronic receipt management server 4 functioning as a receipt management server for customer is described with reference to the block diagram shown in FIG. 5. As shown in FIG. 5, the electronic receipt management server 4 includes a control section 41 for controlling various operations and each section of the electronic receipt management server 4 uniformly. The control section 41 is a computer including a CPU, a ROM for storing various programs and data, a RAM for storing various programs temporarily and overwriting various data freely, and an RTC section for counting the current date and time, and the like.

The control section 41 can be connected with the network N3, network N4 and the network N5 through a communication I/F 42 connected with a bus line 44. The control section 41 is connected with a storage section 43 through the bus line 44.

In addition to a member master management area (not shown) for storing and managing the member master, the storage section 43 further includes an electronic receipt management area 43a for uniformly storing the electronic receipt data of various companies running a store. More specifically, the electronic receipt management area 43a manages the electronic receipt data of various companies running a store for each member.

The electronic receipt data contains a member code, a company code (identification code of a company running a store), a store code, a POS number of a POS terminal 1, a receipt number, commodity sales data (containing date and time data) and the like. Thus, it is possible for, e.g., the consumer goods manufacturer P4 and the like to acquire unique certification information of purchased commodities relating to the manufacturer from the electronic receipt data under a specific condition (for example, limitation of specific company running a store, a specific region limitation, a specific time limitation and the like). The consumer goods manufacturer P4 is a manufacturer of food, drinks, clothing, cosmetics, medicine, daily necessities and the like.

The storage section 43 stores various kinds of additional information in an additional information management area 43b in association with a desired commodity (commodity code), a member (member code), a company (company code) and a store (store code). The additional information is, for example, campaign information relating to the campaign associated with desired commodity information and specific conditions (for example, a specific company running a store, a specific region, a specific store, a specific time and the like). The additional information contains access information such as a URL linking to the homepage associated with the campaign of a company, a URL linking to the homepage associated with the CM of a company, a URL linking to the coupon of a company, and the like.

In addition to the member master management program (not shown) for managing the member master in a member master area, the storage section 43 further includes an electronic receipt management program 43c for the management of the additional information and the electronic receipt data of each company by the electronic receipt management area 43a and the additional information management area 43b. The storage section 43 further includes an information sending program 43d for sending the electronic receipt data and the additional information of a desired commodity to the portable terminal 7. The member master management area, the electronic receipt management area 43a and the additional information management area 43b corresponds to the database DB shown in FIG. 1.

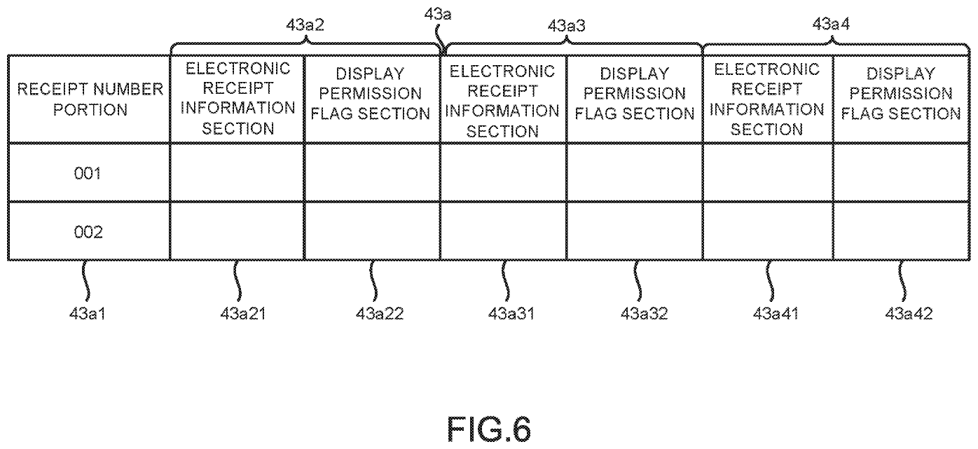

Next, the electronic receipt management area 43a of the electronic receipt management server is described with reference to the memory map shown in FIG. 6.

In FIG. 6, the electronic receipt management area 43a includes a receipt number portion 43a1 and a plurality of electronic receipt data storage sections 43a2-43an corresponding to each receipt number portion 43a1. In the example shown in FIG. 6, three electronic receipt data storage sections (an electronic receipt data storage section 43a2, an electronic receipt data storage section 43a3 and an electronic receipt data storage section 43a4) are shown. The electronic receipt data storage section 43a2 includes an electronic receipt data section 43a21 and a display permission flag section 43a22. The electronic receipt data storage section 43a3 includes an electronic receipt data section 43a31 and a display permission flag section 43a32. The electronic receipt data storage section 43a4 includes an electronic receipt data section 43a41 and a display permission flag section 43a42.

The receipt number portion 43a1 stores a receipt number of a receipt of which the electronic receipt data is already generated. When the receipt number which is not stored yet is received, the new receipt number is stored in a non-storage area of the receipt number portion 43a1.

The electronic receipt data section 43a21 and the electronic receipt data section 43a31 stores different electronic receipt data in association with the receipt number stored in the receipt number portion 43a1. In addition, there is a case in which there is no electronic receipt data stored in the electronic receipt data section 43a31.

The display permission flag section 43a22 and the display permission flag section 43a32 store flags indicating whether or not the electronic receipt data stored in the electronic receipt data section 43a21 and the electronic receipt data section 43a31 can be displayed on the portable terminal 7. In a case in which the stored flag is “1”, the control section 41 carries out a control so that the electronic receipt data can be displayed on the portable terminal 7; in a case in which the stored flag is “0”, the control section 41 carries out a control so that the electronic receipt data cannot be displayed on the portable terminal 7.

When a receipt number and the electronic receipt data corresponding to the receipt number are received from the electronic receipt server 3, and if the receipt number is the first receipt number, the receipt number is stored in the receipt number portion 43a1 and the received electronic receipt data is stored in a corresponding electronic receipt data section 43a21. Then, a flag “1” is stored in the display permission flag section 43a22 corresponding to the electronic receipt data section 43a21. In this case, the electronic receipt data stored in the electronic receipt data section 43a21 can be displayed on the portable terminal 7.

Next, if new electronic receipt data corresponding to the same receipt number is received, the flag stored in the display permission flag section 43a22 is changed to “0”, and the newly received electronic receipt data is stored in the electronic receipt data section 43a31 corresponding to the receipt number. Then, a flag “1” is stored in the display permission flag section 43a32 corresponding to the electronic receipt data section 43a31. In this case, the electronic receipt data stored in the electronic receipt data section 43a21 cannot be displayed on the portable terminal 7, while the electronic receipt data stored in the electronic receipt data section 43a31 can be displayed on the portable terminal 7.

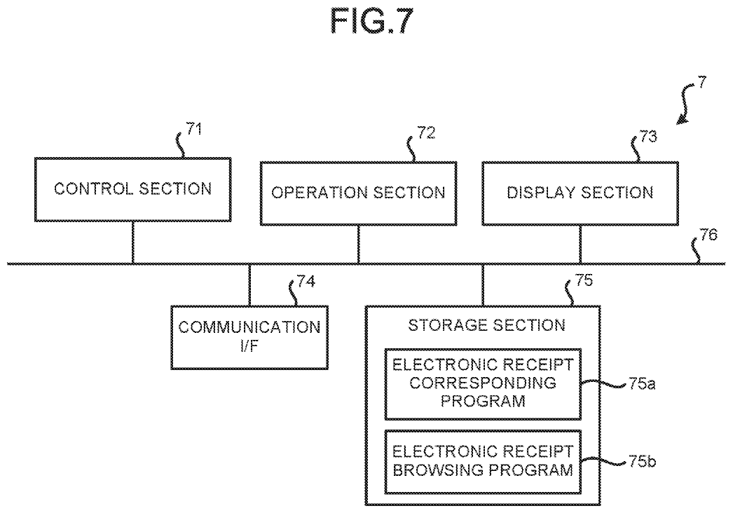

Next, the constitution of the portable terminal 7 is described with reference to the block diagram shown in FIG. 7. As shown in FIG. 7, the portable terminal 7 includes a control section 71 for controlling various operations and each section of the portable terminal 7 uniformly. The control section 71 is a computer including a CPU, a ROM for storing various programs and data, a RAM for storing various programs temporarily and overwriting various data freely, and an RTC section for counting the current date and time, and the like.

An operation section 72 is connected with a display section 73 through a bus line 76. The operation section 72 includes various operation keys for a user (customer) to carry out an input operation and a pointing device. The display section 73, which is, for example, a liquid crystal display and the like, displays various kinds of information such as the later-described electronic receipt data and the like. The display section 73 may be a touch panel, and in this case, the touch panel functions as the operation section 72.

The control section 71 connected with a communication I/F 74 through the bus line 76 can be connected with the network N5 through the communication I/F 74. The control section 71 may also be connected with the in-store network N1 through the communication I/F 74.

The control section 71 is connected with a storage section 75 through the bus line 76. In addition to a Web browser for browsing various kinds of information (contents) disclosed on the Web, the storage section 75 further stores an electronic receipt corresponding program 75a for receiving the electronic receipt data from the electronic receipt management server 4 and an electronic receipt browsing program 75b for browsing the received receipt data.

Next, the control processing of each section constituting the system of the present embodiment is described.

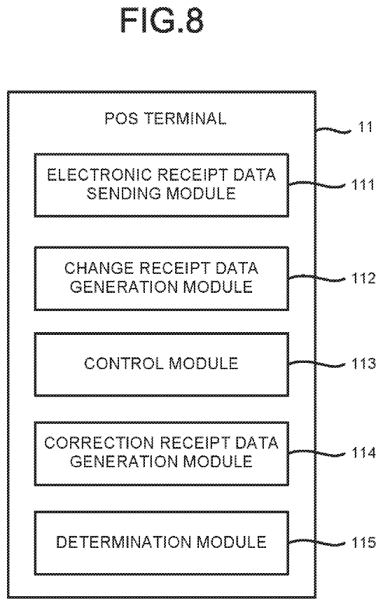

First, the electronic receipt processing, which is executed based on the control of the control section 11 of the POS terminal 1 according to the receipt data processing program 17a, is described with reference to FIG. 8-FIG. 16.

FIG. 8 is a functional block diagram illustrating the functional constitution of the POS terminal 1. The POS terminal 1 realizes, through the control section 11, an electronic receipt data sending module 111, a change receipt data generation module 112, a control module 113, a correction receipt data generation module 114 and a determination module 115. As practical hardware, the CPU of the control section 11 reads and executes the receipt data processing program 17a from the storage section 17 to realize the electronic receipt data sending module 111, the change receipt data generation module 112, the control module 113, the correction receipt data generation module 114 and the determination module 115.

The electronic receipt data sending module 111 has a function of generating electronic receipt data from the receipt data generated based on the transaction information of the commodity subjected to the settlement processing and sending the generated electronic receipt data to the electronic receipt server 3 serving as an external device.

The change receipt data generation module 112 has a function of generating new change receipt data according to the change of the transaction information.

The control module 113 has a function of generating, in a case in which the change receipt data generated by the change receipt data generation module 112 contains a member code serving as customer specification information for specifying the customer, change electronic receipt data from the change receipt data and sending the generated change electronic receipt data to the external device, and outputting printing data based on the generated change electronic receipt data to the printing section.

The correction receipt data generation module 114 has a function of generating new correction receipt data after the change caused by the change of the transaction information.

The determination module 115 has a function of determining whether or not the change receipt data contains a member code serving as the customer specification information.

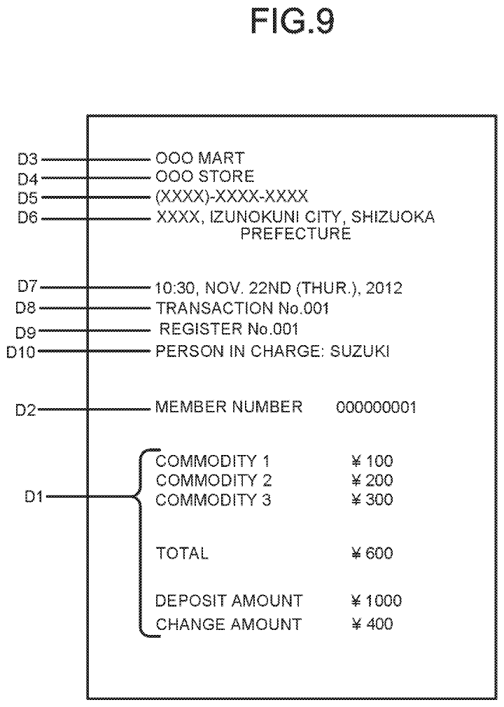

FIG. 9 is a diagram schematically illustrating one example of receipt data. The receipt data is unstructured text data and the like used in the printing carried out by the printing section 13. As shown in FIG. 9, the receipt data contains elements of the aforementioned commodity sales data D1 and member code D2. The commodity sales data D1 contains the commodity name (commodity code) and the amount of a commodity subjected to settlement processing, the total amount of the commodities, the deposit amount paid by the customer, the change amount and the like.

The receipt data further contains elements such as a company code (company name) D3 indicating the company running a store, a store code (store name) D4, a phone number D5 of a store, an address D6, a transaction date and time D7, a transaction number (receipt number) D8, a register number D9, the name of the person in charge D10 and the like. The elements contained in the receipt data are not limited to the example shown in FIG. 9, and the receipt data may further contain other elements such as the business type/business style code and the like, and may not contain elements such as the phone number D5, the address D6 and the like.

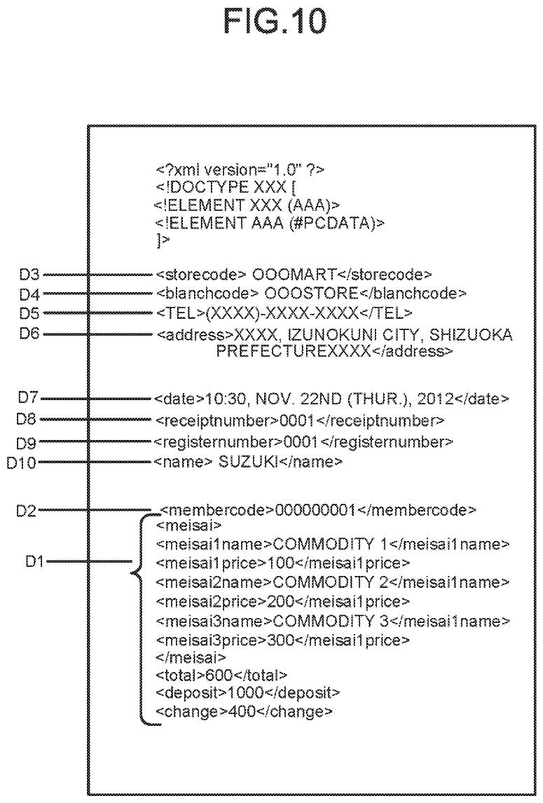

FIG. 10 is a diagram schematically illustrating one example of electronic receipt data. As shown in FIG. 10, the electronic receipt data includes structured data (structured document) such as XML, CSV and the like. FIG. 10 shows an example in which each element (D1-D10) of the receipt data shown in FIG. 9 is converted into the XML format.

The conversion from the receipt data to the electronic receipt data is carried out based on the conversion rules recorded in the receipt data schema 17c. Specifically, given elements constituting the receipt data and attribution information (tag and the like) indicating the attribution of the elements are defined in the receipt data schema 17c. The control section 11 structures each element of the receipt data using the corresponding attribution information to generate the structured electronic receipt data as shown in FIG. 10. By generating such a structured electronic receipt data, the elements contained in the electronic receipt data can be used efficiently, therefore, various advantages can be obtained in the data management.

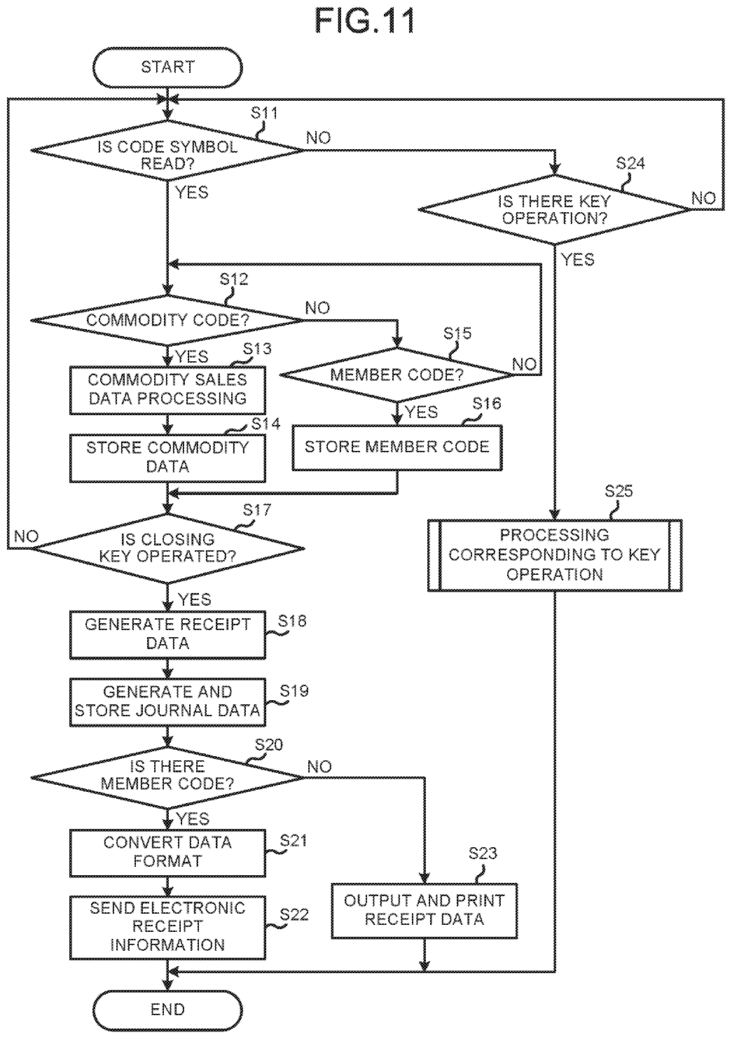

FIG. 11 is a flowchart illustrating the flow of the electronic receipt data processing carried out in the POS terminal 1. First, the control section 11 of the POS terminal 1 determines whether or not the code symbol (commodity code) attached to the commodity or the code symbol (member code) displayed on the portable terminal 7 is read by the code reading section 15 (ACT S11).

If it is determined that the code symbol is read (YES in ACT S11), the control section 11 determines whether or not the information input through the reading processing is the commodity code (ACT S12).

In ACT S12, if it is determined that the input information is the commodity code (YES in ACT S12), the control section 11 executes, if the commodity data of the commodity specified with the commodity code is read from the commodity data file, commodity sales data processing for calculating the settlement amount based on the unit price contained in the commodity data (ACT S13). Next, the control section 11 stores the commodity sales data processed in the commodity sales data processing in the data storage section 17d (ACT S14).

On the other hand, if it is determined that the input information is not the commodity code (NO in ACT S12), the control section 11 determines whether or not the input information is the member code (ACT S15). If it is determined that the input information is the member code (YES in ACT S15), the control section 11 stores the member code in the data storage section 17d (ACT S16). While if it is determined that the input information is not the member code (NO in ACT S15), the control section 11 returns to ACT S12 and waits.

To input the member code to the POS terminal 1, for example, the customer serving as a member displays a code symbol containing the member code and the like on the display section 73 of the portable terminal 7, and then the shop clerk or the customer (serving as a member) himself reads the code symbol through the code reading section 15 of the POS terminal 1. The control section 11 may carry out an exclusive processing and the like so that the input member code is the only during one transaction.

Sequentially, in ACT S17, the control section 11 determines whether or not the start of closing processing is instructed through an operation on the closing key 121 (ACT S17). If the start of closing processing is not instructed (NO in ACT S17), ACT S11 is taken. If the start of closing processing is instructed (YES in ACT S17), the control section 11 generates receipt data based on the commodity sales data or the member code stored in the data storage section 17d (ACT S18).

Then the control section 11 generates journal data based on the generated receipt data (ACT S19). Then the control section 11 stores the generated journal data in the data storage section 17d (ACT S19).

Next, the control section 11 determines whether or not the receipt data contains a member code (ACT S20). If it is determined that the receipt data does not contain the member code (NO in ACT S20), the control section 11 outputs the receipt data of one transaction to the printing section 13 to output the receipt data (ACT S23), and then the present processing is ended. In this way, the receipt data is printed on paper in the printing section 13 and then the paper is cut, and the paper receipt for one transaction is printed and output.

On the other hand, if the receipt data contains the member code (YES in ACT S20), the control section 11 converts the data format of the unstructured receipt data into structured format to generate electronic receipt data (ACT S21). Then, the control section 11 (electronic receipt data sending module 111) sends the generated electronic receipt data to the electronic receipt server 3 together with the receipt number of the receipt through the communication I/F 16 (ACT S22), and then the present processing is ended. The control section 11 further sends the receipt data to the electronic receipt server 3 together with the receipt number. The electronic receipt server 3 stores the received receipt data and electronic receipt data in association with the receipt number.

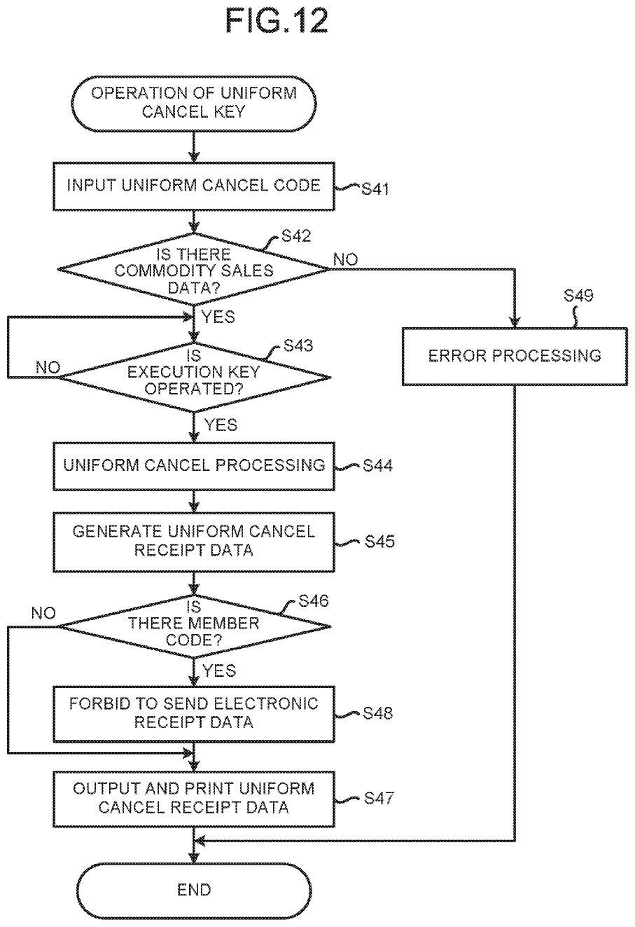

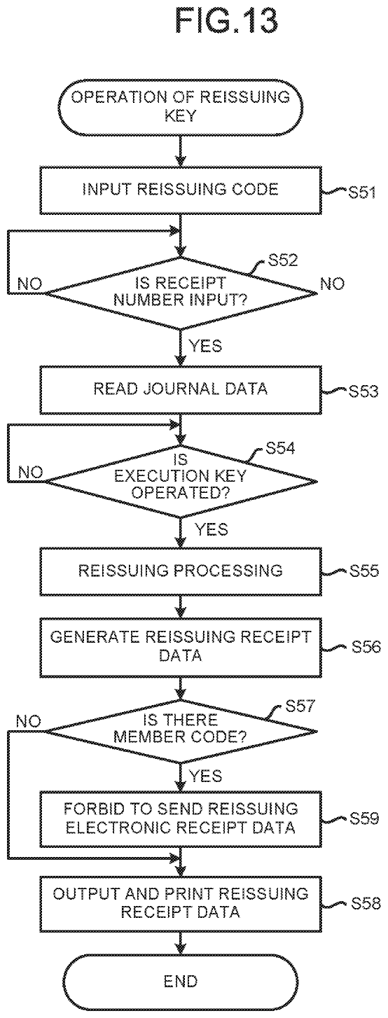

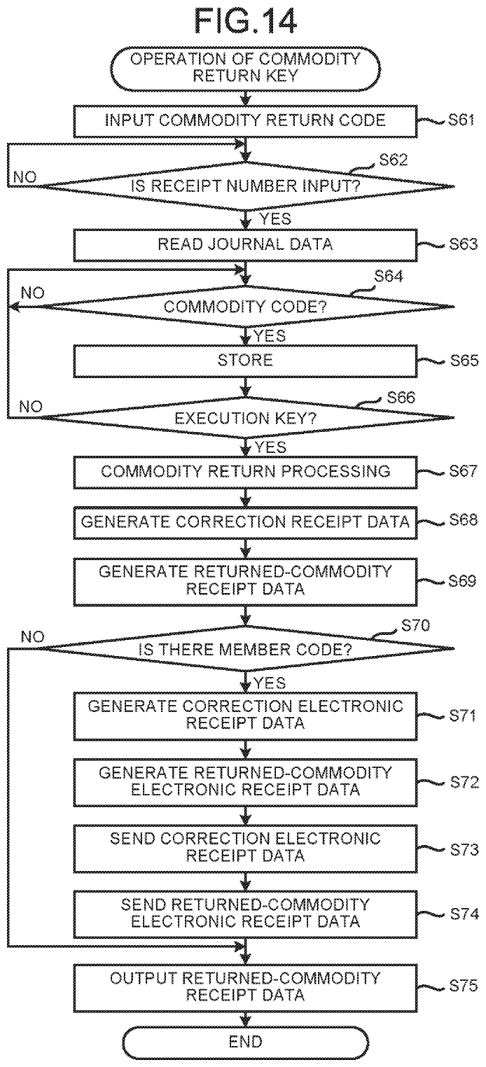

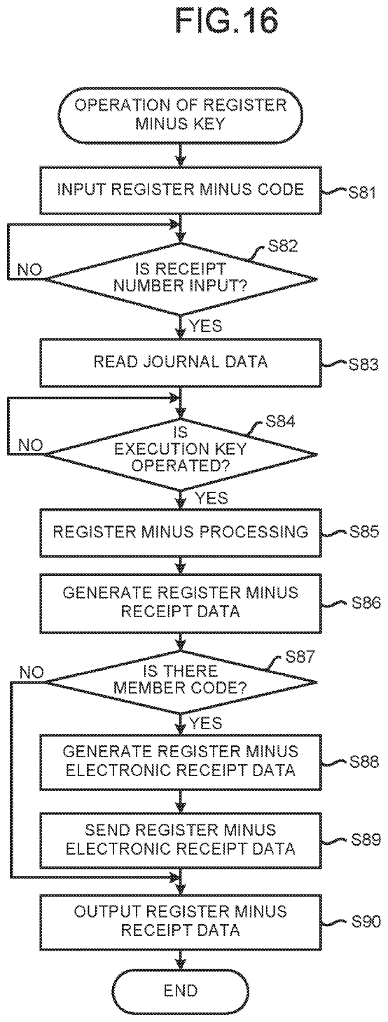

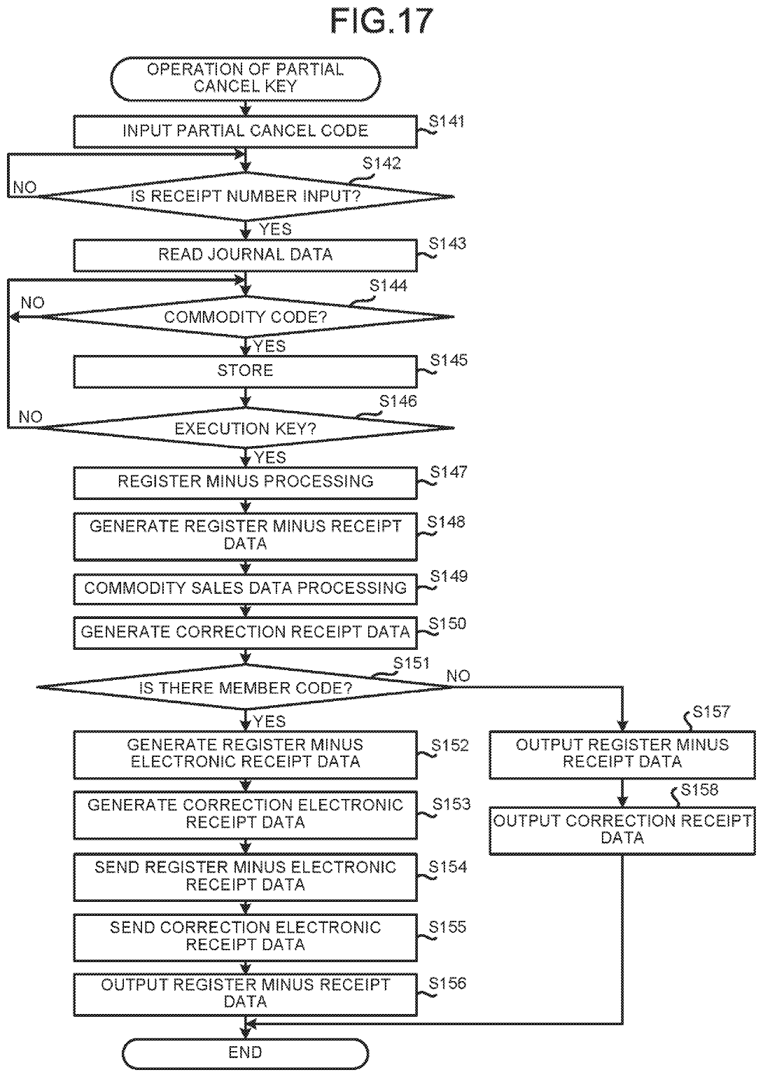

On the other hand, in ACT S11, if it is determined that the code symbol is not read (NO in ACT S11), the control section 11 determines whether or not any of the uniform cancel key 122, the reissuing key 123, the commodity return key 124, the register minus key 125 and the partial cancel key 126 is operated as a specific key (ACT S24). If any of these keys is operated (YES in ACT S24), the control section 11 inputs a specific instruction code of each key and executes the corresponding processing (described in FIG. 12, FIG. 13, FIG. 14, FIG. 16 and FIG. 17) associated with the operation of each key (ACT S25).

FIG. 12 is a flowchart illustrating the detail of the control processing in ACT S25 when the control section 11 determines that the uniform cancel key 122 is operated in ACT S24.

In FIG. 12, the control section 11 inputs, when the uniform cancel key 122 is operated, a uniform cancel code serving as a key code indicating that the uniform cancel key 122 is operated (ACT S41). Sequentially, the control section 11 determines whether or not there is commodity sales data in the data storage section 17d (ACT S42). The commodity sales data is the data subjected to the commodity sales data processing in ACT S13. If it is determined that there is no commodity sales data (NO in ACT S42), the control section 11 regards the operation on the uniform cancel key 122 to be invalid and executes an error processing (ACT S49), and then ends the processing.

If it is determined that there is commodity sales data (YES in ACT S42), the control section 11 determines whether or not the execution key (not shown) for executing the uniform cancel is operated (ACT S43). The control section 11 waits until the execution key is operated (NO in ACT S43), and if it is determined that the execution key is operated (YES in ACT S43), the control section 11 executes uniform cancel processing to stop the current transaction and make the data subjected to the commodity sales data processing in ACT S13 inexistent (ACT S44). Then the control section 11 generates uniform cancel receipt data (change receipt data) containing, for example, header characters of “uniform cancel” based on the commodity sales data which is canceled uniformly and the member code (if there is member code stored in the data storage section 17d) (ACT S45).

Next, the control section 11 determines whether or not there is a member code in the generated uniform cancel receipt data (ACT S46). If it is determined that there is no member code (NO in ACT S46), the control section 11 issues, based on the uniform cancel receipt data, a store reservation-oriented receipt on which the header characters of “uniform cancel” are printed by the printing section 13 (ACT S47).

On the other hand, if it is determined that there is a member code in the generated uniform cancel receipt data (YES in ACT S46), the control section 11 forbids to send the uniform cancel electronic receipt data based on the generated uniform cancel receipt data (ACT S48). In this case, the uniform cancel electronic receipt data may be generated and then the sending of the generated uniform cancel electronic receipt data is forbidden; alternatively, the generation of the uniform cancel electronic receipt data is forbidden to forbid the sending of the uniform cancel electronic receipt data. Then the control section 11 executes the processing in ACT S47.

In the present embodiment, as a processing principle, the electronic receipt data is generated for the receipt data containing a member code and the generated electronic receipt data is sent to the electronic receipt server 3. However, in a case in which the uniform cancel key 122 is operated, the sending of the uniform cancel electronic receipt data is forbidden even if it is determined that the uniform cancel receipt data contains a member code.

FIG. 13 is a flowchart illustrating the detail of the control processing in ACT S25 when the control section 11 determines that the reissuing key 123 is operated in ACT S24.

In FIG. 13, the control section 11 inputs, when the reissuing key 123 is operated, a reissuing code serving as a key code indicating that the reissuing key 123 is operated (ACT S51). Sequentially, the control section 11 determines whether or not the receipt number is input (ACT S52). The receipt number, which is recorded on the receipt handed to the customer or in the electronic receipt data displayed on the customer terminal, is read and input through the operation section 12 by the shop clerk.

The control section 11 waits until the receipt number is input (NO in ACT S52), and if it is determined that the receipt number is input (YES in ACT S52), the control section 11 reads the journal data corresponding to the input receipt number from the data storage section 17d (ACT S53). Then the control section 11 determines whether or not the execution key for executing the reissuing processing is operated (ACT S54).

The control section 11 waits until the execution key is operated (NO in ACT S54), and if it is determined that the execution key is operated (YES in ACT S54), the control section 11 executes receipt reissuing processing based on the read journal data (ACT S55). Sequentially, the control section 11 generates reissuing receipt data (change receipt data) containing, for example, header character of “reissuing” after the receipt reissuing processing (ACT S56).

Next, the control section 11 determines whether or not the generated reissuing receipt data contains a member code (ACT S57). If it is determined that the generated reissuing receipt data does not contain a member code (NO in ACT S57), the control section 11 issues, based on the reissuing receipt data, a receipt which is to be handed to the customer and on which the header character of “reissuing” is printed by the printing section 13 (ACT S58).

On the other hand, if it is determined that the generated reissuing receipt data contains a member code (YES in ACT S57), the control section 11 forbids to send the reissuing electronic receipt data based on the generated reissuing receipt data (ACT S59). In this case, the reissuing electronic receipt data may be generated and then the sending of the generated reissuing electronic receipt data is forbidden; alternatively, the generation of the reissuing electronic receipt data is forbidden to forbid the sending of the reissuing electronic receipt data. Then the control section 11 executes the processing in ACT S58.

In this way, in accordance with the embodiment, in a case in which the changed receipt data contains a member code when the uniform cancel processing or the receipt reissuing processing is executed, the sending of the electronic receipt data is forbidden, therefore, the receipt data of which the changed receipt data does not need to be sent as electronic receipt data is not sent to the customer.

In accordance with the embodiment, the receipt data of which the electronic receipt data is forbidden to be sent is printed by the printing section 13, therefore, the receipt based on the changed receipt data can be reserved by the store.

In accordance with the embodiment, in a case in which the changed receipt data contains a member code, the receipt data is printed by the printing section 13, and therefore, the receipt based on the changed receipt data can be reserved by the store.

In addition to the case in which the uniform cancel key 122 or the reissuing key 123 is operated, in a case in which, for example, the key for issuing a store reservation-oriented receipt is operated, or in a case in which a recall key is operated before the settlement processing in the half-self-processing in which the shop clerk executes commodity registration processing and the customer executes settlement processing by himself, the control section 11 executes the same processing (that is, the processing of outputting data to the printing section 13 and forbidding the sending of the electronic receipt data).

FIG. 14 is a flowchart illustrating the detail of the control processing in ACT S25 when the control section 11 determines that the commodity return key 124 is operated in ACT S24.

In FIG. 14, the control section 11 inputs, when the commodity return key 124 is operated, a commodity return code serving as a key code indicating that the commodity return key 124 is operated (ACT S61). Sequentially, the control section 11 determines whether or not the receipt number is input (ACT S62). The receipt number, which is recorded on the receipt handed to the customer or in the electronic receipt data displayed on the customer terminal, is read and input through the operation section 12 by the shop clerk.

The control section 11 waits until the receipt number is input (NO in ACT S62), and if it is determined that the receipt number is input (YES in ACT S62), the control section 11 reads the journal data corresponding to the input receipt number from the data storage section 17d (ACT S63).

Next, the control section 11 determines whether or not the commodity code of the commodity to be returned is input (ACT S64). The control section 11 waits until the commodity code is input (NO in ACT S64), and if it is determined that the commodity code is input (YES in ACT S64), the control section 11 stores the input commodity code in the data storage section 17d (ACT S65).

Then the control section 11 determines whether or not the execution key is operated (ACT S66). If it is determined that the execution key is not operated (NO in ACT S66), the control section 11 returns to ACT S64, and if it is determined that the execution key is operated (YES in ACT S66), the control section 11 executes the commodity return processing according to the read journal data and the commodity code of the commodity to be returned stored in ACT S65 (ACT S67).

Then the control section 11 (correction receipt data generation module 114) generates, based on the commodity return processing, correction receipt data excluding the commodity sales data of the commodity code input in ACT S64 (ACT S68). Next, the control section 11 (change receipt data generation module 112) generates, based on the commodity sales data of the commodity code input in ACT S64, returned-commodity receipt data (change receipt data) corresponding to the commodity sales data of the commodity to be returned (ACT S69).

Then the control section 11 (determination module 115) determines whether or not the generated correction receipt data and the returned-commodity receipt data contain a member code (ACT S70).

If it is determined that the receipt data contains a member code (YES in ACT S70), the control section 11 (control module 113) converts the data format of the unstructured receipt data into a structured format to generate correction electronic receipt data based on the generated correction receipt data (ACT S71). At this time, the commodity return code input in ACT S61 is assigned. The control section 11 (control module 113) further converts the data format of the unstructured receipt data into a structured format to generate returned-commodity electronic receipt data based on the generated returned-commodity receipt data (ACT S72). At this time, the commodity return code input in ACT S61 is assigned. Then the control section 11 (control module 113) adds the receipt number to the generated correction electronic receipt data and then sends the generated correction electronic receipt data to the electronic receipt server 3 (ACT S73). The control section 11 (control module 113) adds the receipt number to the generated returned-commodity electronic receipt data and then sends the generated returned-commodity electronic receipt data to the electronic receipt server 3 (ACT S74).

Sequentially, the control section 11 (control module 113) outputs the generated returned-commodity receipt data to the printing section 13 (ACT S75). In this way, the control section 11 issues a store reservation-oriented receipt on which the commodity sales data of the returned commodity is printed based on the returned-commodity receipt data. The commodity information of the returned commodity and header characters of “returned commodity” are printed in the store reservation-oriented receipt.

On the other hand, in ACT S70, if it is determined that the receipt data does not contain a member code (NO in ACT S70), the control section 11 executes the processing in ACT S75 and then issues a receipt on which the receipt data is printed.

In this way, in a case in which the commodity return key 124 is operated, the control section 11 executes commodity return processing and generates the correction receipt data and the returned-commodity receipt data. In a case in which the receipt data contains a member code, the correction electronic receipt data and the returned-commodity electronic receipt data are automatically generated and sent to the electronic receipt server 3, and moreover, a paper receipt printed by the printing section 13 based on the returned-commodity receipt data is issued.

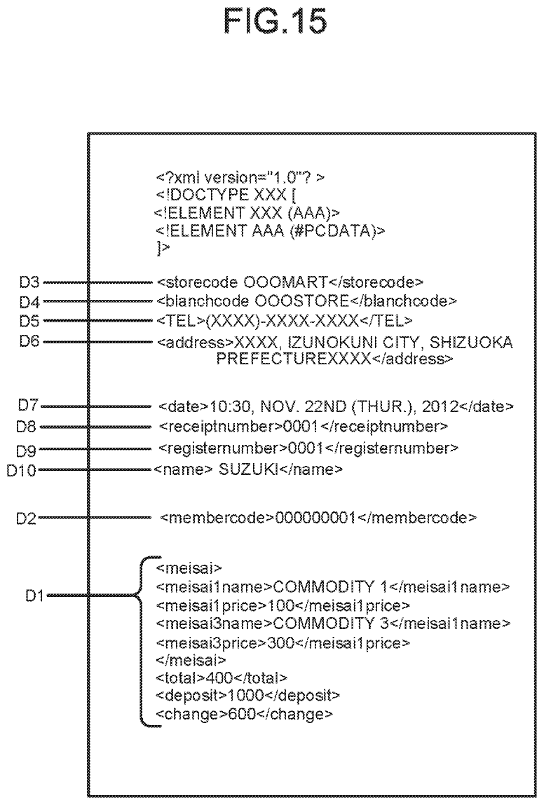

FIG. 15 is a schematic diagram illustrating one example of the correction electronic receipt data generated in the commodity return processing described in FIG. 14. FIG. 15 shows an example in which a commodity 2 is returned from the electronic receipt data shown in FIG. 10. In the electronic receipt data shown in FIG. 10, the electronic receipt data containing a commodity 1, the commodity 2 and a commodity 3 is generated as the commodity sales data D1, however, since the commodity 2 is returned, therefore, in the example shown in FIG. 15, new electronic receipt data containing the commodity 1 and the commodity 3 other than the commodity 2 is generated.

FIG. 16 is a flowchart illustrating the detail of the control processing in ACT S25 when the control section 11 determines that the register minus key 125 is operated in ACT S24.

In FIG. 16, the control section 11 inputs, when the register minus key 125 is operated, a register minus code serving as a key code indicating that the register minus key 125 is operated (ACT S81). Sequentially, the control section 11 determines whether or not the receipt number is input (ACT S82). The receipt number, which is recorded on the receipt handed to the customer or in the electronic receipt data displayed on the customer terminal, is read and input through the operation section 12 by the shop clerk.

The control section 11 waits until the receipt number is input (NO in ACT S82), and if it is determined that the receipt number is input (YES in ACT S82), the control section 11 reads the journal data managed with the input receipt number from the data storage section 17d (ACT S83).

Then the control section 11 determines whether or not the execution key is operated (ACT S84). The control section 11 waits until the execution key is operated (NO in ACT S84), and if it is determined that the execution key is operated (YES in ACT S84), the control section 11 executes register minus processing based on the journal data read in ACT S83 (ACT S85). The register minus processing is a processing for cancelling the transaction which has been established already. Sequentially, the control section 11 (change receipt data generation module 112) generates register minus receipt data (change receipt data) based on the register minus processing (ACT S86).

Next, the control section 11 (determination module 115) determines whether or not the generated register minus receipt data contains a member code (ACT S87). If it is determined that the generated register minus receipt data contains a member code (YES in ACT S87), the control section 11 (control module 113) converts the data format of the unstructured register minus receipt data into a structured format to generate register minus electronic receipt data based on the register minus receipt data (ACT S88). At this time, the register minus code input in ACT S81 is assigned. Then the control section 11 (control module 113) adds the receipt number to the generated register minus electronic receipt data and then sends the register minus electronic receipt data to the electronic receipt server 3 (ACT S89). The control section 11 (control module 113) outputs the register minus receipt data to the printing section 13 to execute printing processing (ACT S90), and issues a store reservation-oriented paper register minus receipt on which header characters of “register minus” are printed.

On the other hand, in ACT S87, if it is determined that the register minus receipt data does not contain a member code (NO in ACT S87), the control section 11 executes the processing in ACT S90.

In this way, in a case in which the register minus key 125 is operated, the control section 11 executes register minus processing and generates register minus receipt data. In a case in which the register minus receipt data contains a member code, the register minus electronic receipt data is automatically generated and sent to the electronic receipt server 3, and moreover, a paper receipt printed by the printing section 13 based on register minus receipt data is issued.

Next, the control processing in ACT S25 when the control section 11 determines that the partial cancel key 126 is operated in ACT S24 is described with reference to the flowchart shown in FIG. 17. In FIG. 17, the control section 11 inputs, when the partial cancel key 126 is operated, a partial cancel code serving as a key code indicating that the partial cancel key 126 is operated (ACT S141). Sequentially, the control section 11 determines whether or not the receipt number is input (ACT S142). The receipt number, which is recorded on the receipt handed to the customer or in the electronic receipt data displayed on the customer terminal, is read and input through the operation section 12 by the shop clerk.

The control section 11 waits until the receipt number is input (NO in ACT S142), and if it is determined that the receipt number is input (YES in ACT S142), the control section 11 reads the journal data managed with the input receipt number from the data storage section 17d (ACT S143).

Next, the control section 11 determines whether or not the commodity code of the commodity to be canceled is input (ACT S144). The control section 11 waits until the commodity code is input (NO in ACT S144), and if it is determined that the commodity code is input (YES in ACT S144), the control section 11 stores the input commodity code in the data storage section 17d (ACT S145).

Then the control section 11 determines whether or not the execution key is operated (ACT S146). If it is determined that the execution key is not operated (NO in ACT S146), the control section 11 returns to ACT S144, and if it is determined that the execution key is operated (YES in ACT S146), the control section 11 executes the register minus processing based on the read journal data (ACT S147). Then the control section 11 (change receipt data generation module 112) generates register minus receipt data (change receipt data) based on the register minus processing (ACT S148).

Next, the control section 11 executes commodity sales data processing for the commodity which is not canceled according to the journal data and the commodity code of the canceled commodity stored in ACT S145 (ACT S149). Then the control section 11 (correction receipt data generation module 114) generates correction receipt data based on the commodity sales data processing (ACT S150).

Then the control section 11 (determination module 115) determines whether or not the generated register minus receipt data and the correction receipt data contain a member code (ACT S151).

If it is determined that the receipt data contains a member code (YES in ACT S151), the control section 11 (control module 113) converts the data format of the unstructured register minus receipt data into a structured format to generate register minus electronic receipt data based on the register minus receipt data (ACT S152). At this time, the partial cancel code input in ACT S141 is assigned. Character data of “register minus” is contained in the register minus electronic receipt data.

The control section 11 (control module 113) further converts the data format of the unstructured correction receipt data into a structured format to generate correction electronic receipt data based on the correction receipt data (ACT S153). At this time, the partial cancel code input in ACT S141 is assigned. Then the control section 11 (control module 113) sends the generated register minus electronic receipt data to the electronic receipt server 3 (ACT S154). The control section 11 (control module 113) further adds the receipt number to the generated correction electronic receipt data and then sends the generated correction electronic receipt data to the electronic receipt server 3 (ACT S155).

Sequentially, the control section 11 (control module 113) outputs the register minus receipt data to the printing section 13 to execute printing processing (ACT S156), and issues a store reservation-oriented paper register minus receipt on which the header characters of “register minus” are printed

On the other hand, in ACT S151, if it is determined that the generated register minus receipt data and the correction receipt data do not contain a member code (NO in ACT S151), the control section 11 outputs the generated register minus receipt data to the printing section 13 to execute printing processing (ACT S157), and issues a store reservation-oriented paper register minus receipt on which the header characters of “register minus” are printed. The control section 11 further outputs the generated correction receipt data to the printing section 13 to execute printing processing (ACT S158), and issues a paper correction receipt which is to be handed to the customer and on which the characters of “partial cancel” are printed.

In addition to the case in which the commodity return key 124, the register minus key 125 or the partial cancel key 126 is operated, in a case in which, for example, the key for changing the purchase of a revenue stamp is operated, the control section 11 executes the same processing.

In this way, according to the embodiment, in a case in which the generated change receipt data contains customer specification information for specifying a customer, the change electronic receipt data is generated from the change receipt data and sent to the external device, and moreover, the printing data based on the change electronic receipt data is output to the printing section, thus, the changed receipt data can be sent to the customer as electronic receipt data and can be printed by the printing section 13.

In accordance with the embodiment, in a case in which the commodity return processing and the partial cancel processing are executed, new correction receipt data is generated after the change caused by the change of the transaction information, thus, the changed electronic receipt data can be sent.

In accordance with the embodiment, in a case in which it is determined that the change receipt data contains a member code serving as the customer specification information, the change electronic receipt data is generated from the change receipt data and sent to the external device, and moreover, the printing data based on the change electronic receipt data is output to the printing section 13, thus, the electronic receipt data can be sent automatically.

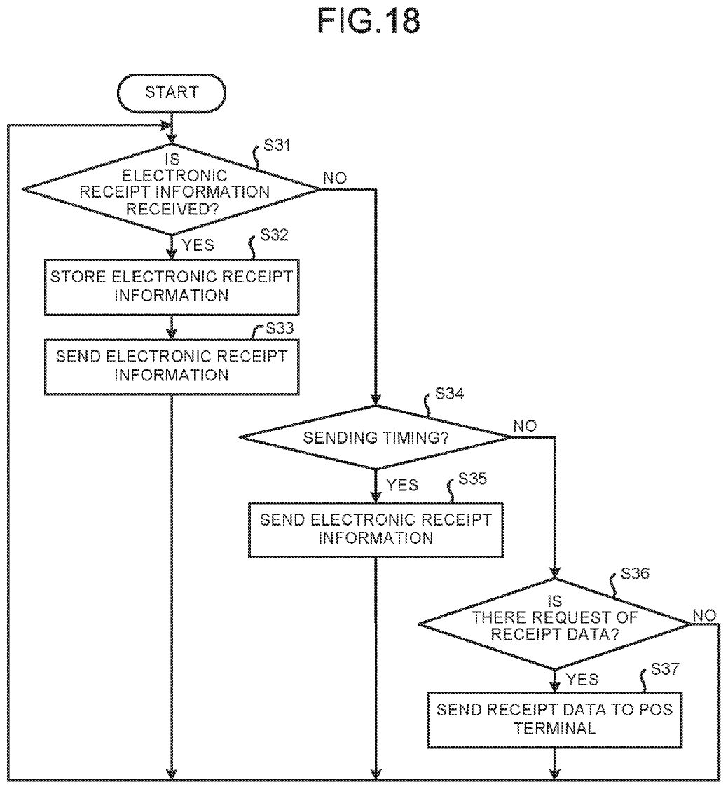

Next, the flow of electronic receipt management processing executed through the operations of the control section 31 of the electronic receipt server 3 according to the electronic receipt management program 33b and the flow of information sending processing executed through the operations of the control section 31 according to the information sending program 33c are described with reference to the flowchart shown in FIG. 18.

If the electronic receipt data sent from the POS terminal 1 is received through the communication I/F 32 (YES in ACT S31), the control section 31 of the electronic receipt server 3 stores the data in the electronic receipt management area 33a of the storage section 33 as the electronic receipt data of each company (ACT S32). Then the control section 31 of the electronic receipt server 3 sends the electronic receipt data stored in ACT S32 to the electronic receipt management server 4 (ACT S33), and then ACT S31 is taken.

If it is the preset sending timing (NO in ACT S31→YES in ACT S34), the control section 31 of the electronic receipt server 3 sends the electronic receipt data stored and managed in the electronic receipt management area 33a to the electronic receipt management server 4 (ACT S35), and then ACT S31 is taken. Through the sending processing in ACT S35, for example, the electronic receipt data omitted from the sending target in ACT S33 can be sent to the electronic receipt management server 4. It is also applicable to carry out a control to merely send the unsent electronic receipt data in ACT S35.

If it is determined not to be the preset sending timing in ACT S34 (NO in ACT S34), the control section 31 determines whether or not there is a request of receipt data from the POS terminal 1 (ACT S36). The request of receipt data is sent from the POS terminal 1 in ACT S52, ACT S62 and ACT S82.

If it is determined that there is a request of receipt data (YES in ACT S36), the control section 31 sends the receipt data designated with the receipt number received together with the request of receipt data to the POS terminal 1 (ACT S37). On the other hand, if it is determined that there is no request of receipt data (NO in ACT S36), the control section 31 returns to ACT S31.

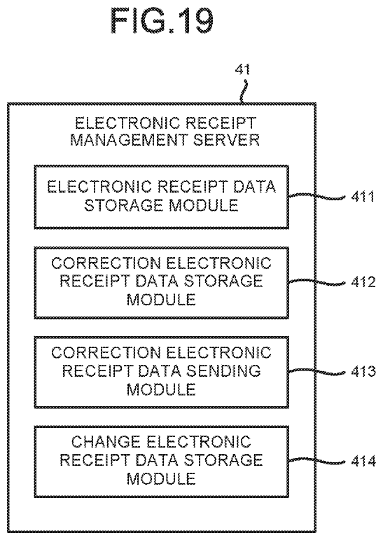

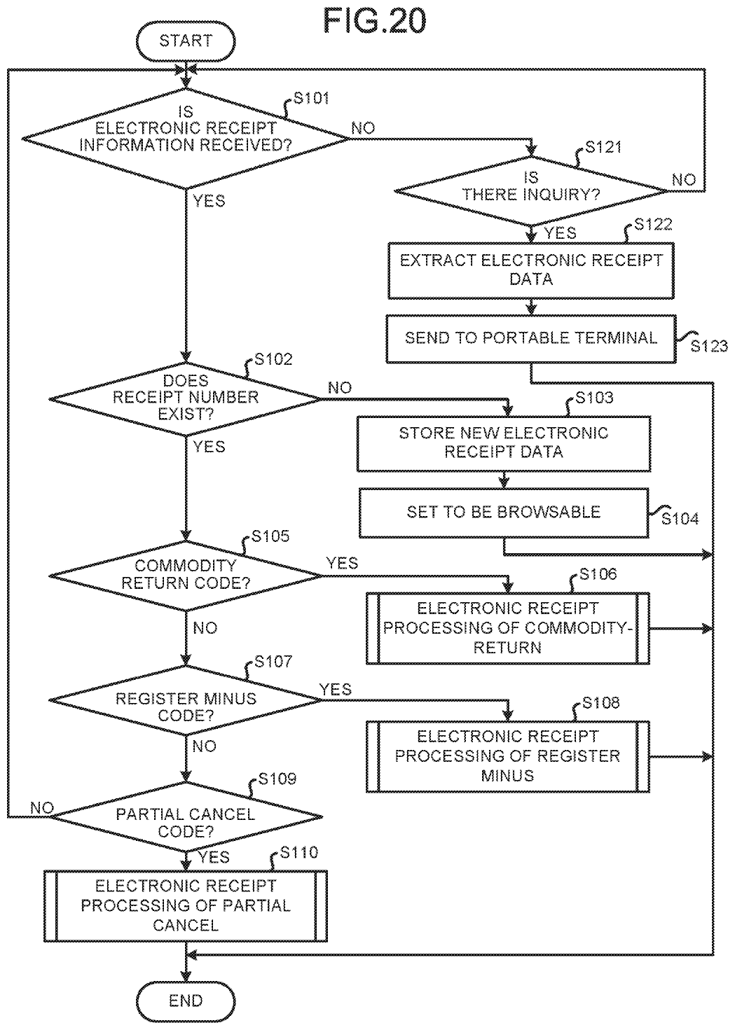

Next, the flow of electronic receipt management processing executed through the operations of the control section 41 of the electronic receipt management server 4 according to the electronic receipt management program 43c and the flow of commodity information sending processing executed through the operations of the control section 41 according to the information sending program 43d are described with reference to the functional block diagram shown in FIG. 19 and the flowchart shown in FIG. 20.

As shown in FIG. 19, the electronic receipt management program 43c and the information sending program 43d executed by the electronic receipt management server 4 have a module constitution containing an electronic receipt data storage module 411, a correction electronic receipt data storage module 412, a correction electronic receipt data sending module 413 and a change electronic receipt data storage module 414. As practical hardware, the CPU of the control section 41 reads and executes the electronic receipt management program 43c and the information sending program 43d from the storage section 43 to realize the electronic receipt data storage module 411, the correction electronic receipt data storage module 412, the correction electronic receipt data sending module 413 and the change electronic receipt data storage module 414.

The electronic receipt data storage module 411 has a function of storing electronic receipt data, which is generated by the commodity sales data processing apparatus 1 based on one transaction with the customer, in a storage section in a browsable manner.

The correction electronic receipt data storage module 412 has a function of storing changed correction electronic receipt data, which is obtained by changing the electronic receipt data stored by the electronic receipt data storage module 411 according to the change of the transaction, instead of the electronic receipt data, in a storage section in a browsable manner.

The correction electronic receipt data sending module 413 has a function of sending, in response to a browsing request from the terminal device 7, the correction electronic receipt data stored by the correction electronic receipt data storage module 412 to the terminal device 7.

The change electronic receipt data storage module 414 has a function of storing, in a storage section, change electronic receipt data obtained by changing the electronic receipt data stored by the electronic receipt data storage module 411 according to the change of the transaction.

As shown in FIG. 20, the control section 41 of the electronic receipt management server 4 determines whether or not the electronic receipt data sent from the electronic receipt server 3 of each company is received through the communication I/F 42 (ACT S101).

If it is determined that the electronic receipt data is received (YES in ACT S101), the control section 41 determines whether or not the receipt number received at the same time already exists (ACT S102). The determination is carried out by determining whether or not there is received receipt number in the receipt number portion 43a1 of the electronic receipt management area 43a (ACT S102).

If it is determined that the receipt number does not exist (NO in ACT S102), the control section 41 stores new electronic receipt data in the electronic receipt data section 43a21 in association with the received receipt number (ACT S103). Then the control section 41 stores a flag “1” in the display permission flag section 43a22 in association with the stored new electronic receipt data to set the electronic receipt data to be browsable (ACT S104).

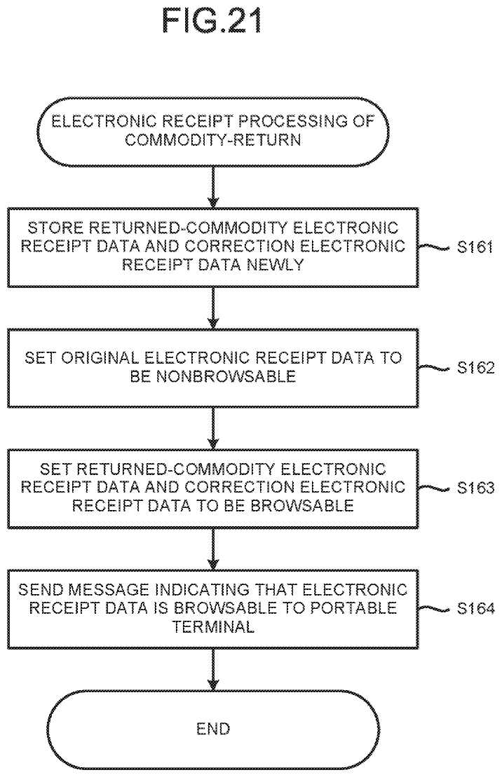

On the other hand, if it is determined that the received receipt number already exists (YES in ACT S102), the control section 41 determines whether or not the received electronic receipt data contains a commodity return code (ACT S105). If it is determined that the received electronic receipt data contains a commodity return code (YES in ACT S105), the control section 41 executes electronic receipt processing of commodity-return shown in FIG. 21 (ACT S106).

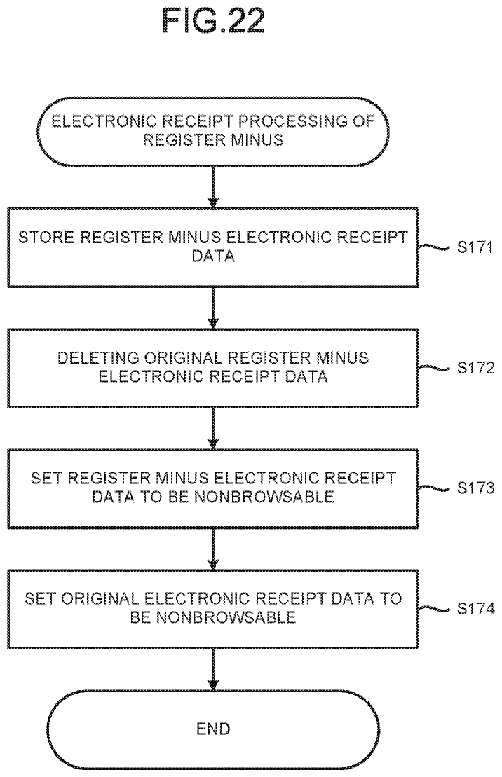

On the other hand, if it is determined that the received electronic receipt data does not contain a commodity return code (NO in ACT S105), the control section 41 determines whether or not the received electronic receipt data contains a register minus code (ACT S107). If it is determined that the received electronic receipt data contains a register minus code (YES in ACT S107), the control section 41 executes electronic receipt processing of register minus shown in FIG. 22 (ACT S108).

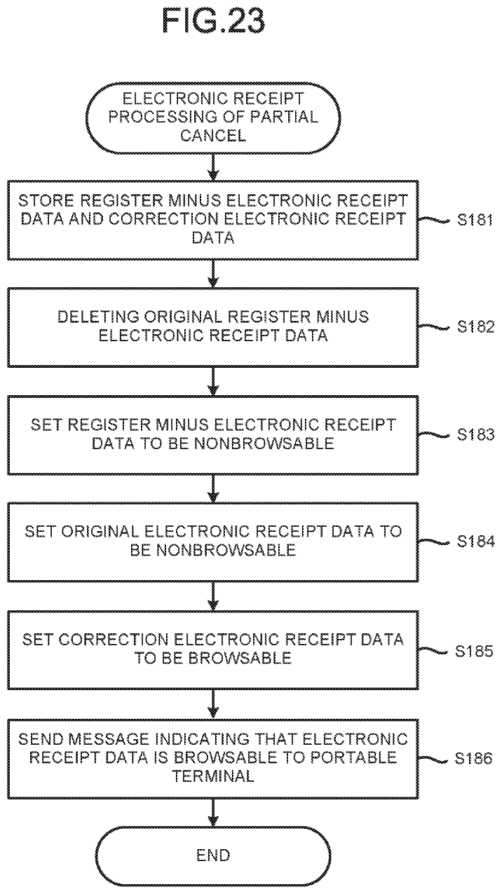

On the other hand, if it is determined that the received electronic receipt data does not contain a register minus code (NO in ACT S107), the control section 41 determines whether or not the received electronic receipt data contains a partial cancel code (ACT S109). If it is determined that the received electronic receipt data contains a partial cancel code (YES in ACT S109), the control section 41 executes electronic receipt processing of partial cancel shown in FIG. 23 (ACT S110). On the other hand, if it is determined that the received electronic receipt data does not contain a partial cancel code (NO in ACT S109), the control section 41 returns to ACT S101 and waits.

On the other hand, in ACT S101, if it is determined that the electronic receipt data is not received (NO in ACT S101), the control section 41 determines whether or not there is an electronic receipt data inquiry from the portable terminal 7 (ACT S121). If it is determined that there is an electronic receipt data inquiry (YES in ACT S121), the control section 41 reads the electronic receipt data from the electronic receipt management area 43a (ACT S122). Then the control section 41 sends the read electronic receipt data to the portable terminal 7 which sent the inquiry (ACT S123).

FIG. 21 is a flowchart illustrating the electronic receipt processing of commodity-return shown in ACT S106. The control section 41 stores the received returned-commodity electronic receipt data in the electronic receipt data section 43a31 corresponding to the received receipt number (ACT S161). The control section 41 further stores the received correction electronic receipt data in the electronic receipt data section 43a41 corresponding to the received receipt number (ACT S161).

Next, the control section 41 set the flag of the display permission flag section 43a22 to “0” to make the original electronic receipt data nonbrowsable (ACT S162). Then the control section 41 sets the flag of the display permission flag section 43a32 and the flag of the display permission flag section 43a42 to “1” to make the returned-commodity electronic receipt data stored in the electronic receipt data section 43a31 and the correction electronic receipt data stored in the electronic receipt data section 43a41 browsable (ACT S163).

Sequentially, the control section 41 sends a message indicating that the returned-commodity electronic receipt data and the correction electronic receipt data are browsable to the portable terminal 7 (ACT S164).

FIG. 22 is a flowchart illustrating the electronic receipt processing of register minus shown in ACT S108. The control section 41 stores the received register minus electronic receipt data in the electronic receipt data section 43a31 corresponding to the received receipt number (ACT S171).

Next, the control section 41 executes a processing of deleting the electronic receipt data stored in the electronic receipt data section 43a21 based on the register minus electronic receipt data stored in the electronic receipt data section 43a31 (ACT S172). Then the control section 41 sets the flag of the display permission flag section 43a32 to “0” to make the register minus electronic receipt data stored in the electronic receipt data section 43a31 nonbrowsable (ACT S173). Sequentially, the control section 41 sets the flag of the display permission flag section 43a22 to “0” to make the original electronic receipt data stored in the electronic receipt data section 43a21 nonbrowsable (ACT S174).

FIG. 23 is a flowchart illustrating the electronic receipt processing of partial cancel shown in ACT S110. The control section 41 stores the received register minus electronic receipt data in the electronic receipt data section 43a31 corresponding to the received receipt number (ACT S181). The control section 41 further stores the received correction electronic receipt data in the electronic receipt data section 43a41 corresponding to the received receipt number (ACT S181).

Next, the control section 41 executes a processing of deleting the electronic receipt data stored in the electronic receipt data section 43a21 based on the register minus electronic receipt data stored in the electronic receipt data section 43a31 (ACT S182). Then the control section 41 sets the flag of the display permission flag section 43a32 to “0” to make the register minus electronic receipt data stored in the electronic receipt data section 43a31 nonbrowsable (ACT S183). Sequentially, the control section 41 sets the flag of the display permission flag section 43a22 to “0” to make the electronic receipt data stored in the electronic receipt data section 43a21 nonbrowsable (ACT S184).

The control section 41 sets the flag of the display permission flag section 43a42 to “1” to make the correction electronic receipt data stored in the electronic receipt data section 43a41 browsable (ACT S185).

The control section 41 sends a message indicating that the correction electronic receipt data is browsable to the portable terminal 7 (ACT S186).

In such an embodiment, in a case of executing commodity return processing for a transaction in which the transaction is ended and the electronic receipt data is generated, the control section 41 receives the returned-commodity electronic receipt data and the correction electronic receipt data from the electronic receipt server 3. In a case in which there is a browsing inquiry of the electronic receipt data from the portable terminal 7 after these electronic receipt data are received, the electronic receipt management server 4 sends the returned-commodity electronic receipt data and the correction electronic receipt data corresponding to the display permission flag section of which the flag is set to “1” to the portable terminal 7. The previous electronic receipt data of which the flag is set to “0” is not sent. That is, after the commodity return processing, the returned-commodity electronic receipt data and the correction electronic receipt data can be browsed while the original electronic receipt data cannot be browsed through the portable terminal 7.

In the present embodiment, in a case of executing the register minus processing for the transaction in which the transaction is ended and the electronic receipt data is generated, the control section 41 received the register minus electronic receipt data from the electronic receipt server 3. In a case in which there is a browsing inquiry of the electronic receipt data from the portable terminal 7 after the register minus electronic receipt data is received, the control section 41 does not send the original electronic receipt data and the register minus electronic receipt data to the portable terminal 7. That is, neither the original electronic receipt data nor the register minus electronic receipt data can be browsed through the portable terminal 7.

In the present embodiment, in a case of executing the partial cancel processing for the transaction in which the transaction is ended and the electronic receipt data is generated, the control section 41 receives the register minus electronic receipt data and the correction electronic receipt data from the electronic receipt server 3. In a case in which there is a browsing inquiry of the electronic receipt data from the portable terminal 7 after these electronic receipt data are received, the electronic receipt management server 4 sends the correction electronic receipt data corresponding to the display permission flag section of which the flag is set to “1” to the portable terminal 7, while the register minus electronic receipt data and the previous electronic receipt data when the flags are set to “0” are not sent. That is, after the partial cancel processing, the correction electronic receipt data can be browsed while the register minus electronic receipt data and the original electronic receipt data cannot be browsed through the portable terminal 7.

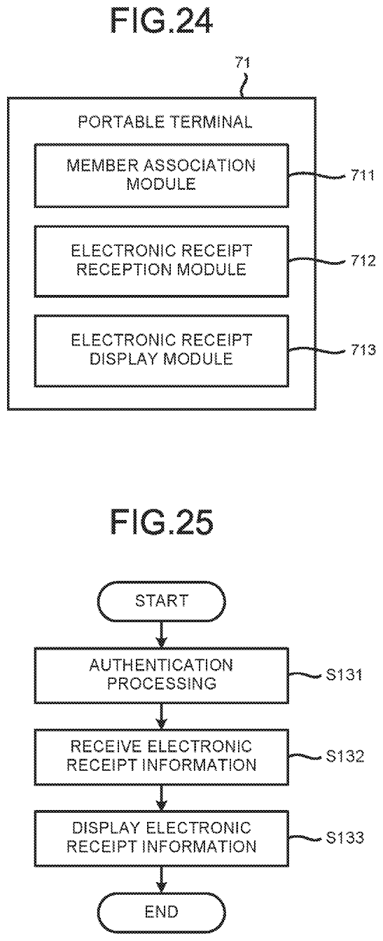

Next, the flow of electronic receipt reception processing executed through the operations of the control section 71 of the portable terminal 7 according to the electronic receipt corresponding program 75a and the flow of electronic receipt browsing processing executed through the operations of the control section 71 according to the electronic receipt browsing program 75b are described with reference to FIG. 24-FIG. 26.

As shown in FIG. 24, the electronic receipt corresponding program 75a and the electronic receipt browsing program 75b executed by the portable terminal 7 have a module constitution containing a member association module 711, an electronic receipt reception module 712 and an electronic receipt display module 713. As practical hardware, the CPU of the control section 71 reads and executes the electronic receipt corresponding program 75a and the electronic receipt browsing program 75b from the storage section 75 to load each section mentioned above onto the RAM and to generate the member association module 711, the electronic receipt reception module 712 and the electronic receipt display module 713 on the RAM.

The member association module 711 associates the member code of a given customer with the portable terminal 7. The electronic receipt reception module 712 receives electronic receipt data from the electronic receipt management server 4. The electronic receipt display module 713 displays the electronic receipt data received by the electronic receipt reception module 712 on the display section 73.

As shown in FIG. 25, first, the member association module 711 of the portable terminal 7 accesses the electronic receipt management server 4 and inputs the member code and the pass word to execute authentication processing (ACT S131). In this way, the portable terminal 7 is associated with the member code of a given customer.

After the authentication, the electronic receipt reception module 712 of the portable terminal 7 receives electronic receipt data stored and managed in the electronic receipt management area 43a of the electronic receipt management server 4 corresponding to the input member code (ACT S132). In a case in which additional information is associated with the electronic receipt data, the additional information is also received from the electronic receipt management server 4. The receipt data may be received through an E-mail.

Next, the electronic receipt display module 713 of the portable terminal 7 displays the electronic receipt data and the like received by the electronic receipt reception module 712 on the display section 73 (ACT S133), and then the processing is ended.

FIG. 26 is a diagram illustrating one example of an electronic receipt G2 displayed on the display section 73 of the portable terminal 7. The electronic receipt G2 is displayed in such a manner that the layout and the content thereof are the same as the receipt printed on paper. In the electronic receipt G2, a commodity a indicating the transacted commodities and the like can be brought into focus by the cursor that follows the input through the operation section 72. In the example shown in FIG. 26, the electronic receipt G2 contains a store name logo part G21 for displaying the logo of the store name and a banner display part G22 for displaying an advertisement and the like.

In addition, the display form of the receipt data is not limited to be matched with the image of the receipt printed on paper. However, the receipt data, which is the replacement of the paper receipt, is electronic commodity purchase certificate information for proving the purchase of the commodity a. The receipt is prompted as commodity purchase certificate information, thus, for example, the receipt shown in FIG. 26 contains the following information:
store name
purchase date and time
purchased commodity detail
sales total amount
deposit amount
change amount
register number
transaction number

In a case in which a plurality of receipt data is received, a selection screen may be displayed through which each of the receipt data can be selected based on the purchase date and time, the company code and the like contained in the receipt data. In this case, the electronic receipt display module 713 displays the receipt data selected from the selection screen on the display section 73.

While certain embodiments have been described, these embodiments have been presented by way of example only, and are not intended to limit the scope of the invention. Indeed, the novel embodiments described herein may be embodied in a variety of other forms; furthermore, various omissions, substitutions changes and combinations in the form of the embodiments described herein may be made without departing from the spirit of the invention. The accompanying claims and their equivalents are intended to cover such forms or modifications as would fall within the scope and spirit of the invention.

For example, though it is exemplified in the embodiment described above that the member code and the like are input through the code reading section 15, the present invention is not limited to this, and the member code and the like may be input through other methods. Specifically, a near-distance wireless communication section such as a NFC (Near Field Communication), a Bluetooth (registered trademark) and the like may be arranged in the POS terminal 1 and the portable terminal 7, and the member code and the like may be transmitted and received through near-distance wireless communication. In this case, the portable terminal 7 stores the member code and the like in the storage section 75 or an IC tag (not shown) and the like.

Though it is exemplified in the embodiment described above that the member code and the like are input from the portable terminal 7, the present invention is not limited to this. For example, the member code may be input from a medium, such as an IC card or a magnetic card and the like, that can store the member code. In a case in which an IC card is used, the POS terminal 1 is provided with a reading/writing section such as an IC card reader-writer. In a case in which a magnetic card is used, the POS terminal 1 is provided with, for example, a card reader/card writer of the magnetic card.

It is exemplified in the embodiment described above that the electronic receipt server 3 is arranged in the headquarters P2, however, the present invention is not limited to this. The electronic receipt server 3 for store may be arranged in the store P1. In this case, the POS terminal 1 outputs electronic receipt data to the electronic receipt server 3 connected with the in-store network N1 thereof, and the electronic receipt server 3 sends the electronic receipt data to the electronic receipt management server 4 through the in-store network N1 and the network N2.

It is exemplified in the embodiment described above that the electronic receipt data generated by the POS terminal 1 is output to the electronic receipt management server 4 via the electronic receipt server 3, however, the present invention is not limited to this. The electronic receipt data may be output directly to the electronic receipt management server 4 by accessing the electronic receipt management server 4 from the POS terminal 1 through the network N3.

Though it is exemplified in the embodiment described above that the portable terminal 7 receives the electronic receipt data via the electronic receipt management server 4, the present invention is not limited to this. For example, the portable terminal 7 may receive the electronic receipt data directly from the POS terminal 1. In this case, the POS terminal 1 outputs the generated electronic receipt data to the portable terminal 7 connected through the in-store network N1 or a near-distance wireless communication section (not shown). In this case, the authentication processing may be carried out in the POS terminal 1.

Furthermore, it is exemplified in the embodiment described above that the commodity data file is stored in the POS terminal 1, however, the present invention is not limited to this. The commodity data file may be stored in the store server 2 in a referable manner from the POS terminal 1.

What is claimed is:

1. An electric receipt system comprising:
a point-of-sales terminal that generates electric receipt data; and
an electric receipt management server that sends the electric receipt data to a portable terminal, wherein
the point-of-sales terminal comprises
a memory, and
a processor configured to:
generate, in response to an input of a commodity code for specifying a commodity to return after sending the electric receipt data, corrected electric receipt data containing commodities included in the electric receipt data except for a commodity with the commodity code,
send the corrected electric receipt data, and
generate, in response to an input of a commodity code for specifying a commodity to return after sending the electric receipt data, returned-commodity receipt data according to the commodity code, and
a printer configured to print a return receipt on the basis of the returned-commodity receipt data, the return receipt indicating a returned commodity; and
the electric receipt management server comprises
a memory; and
a processor configured to:
receive the corrected electric receipt data, and
send the corrected electric receipt data to the portable terminal.

2. The electric receipt system according to claim 1, wherein
the printer prints the returned-commodity receipt data to which information representing the retuned commodity is added.

3. The electric receipt system according to claim 1, wherein
the processor of the point-of-sales terminal is further configured to:
generate electric returned-commodity receipt data on the basis of the returned-commodity receipt data, and
send the electric returned-commodity receipt data; and
the processor of the electric receipt management server is further configured to:
receive the electric returned-commodity receipt data, and
send the electric returned-commodity receipt data to the portable terminal.

4. The electric receipt system according to claim 1, wherein the processor of the point-of-sales terminal is further configured to:
generate, in response to an input of a commodity code for specifying a commodity to return after sending the electric receipt data to an external device, corrected receipt data excluding a commodity with the commodity code, and
generate electric corrected receipt data from the corrected receipt data when the corrected receipt data contains customer specification information for specifying a customer.

5. A management method for an electric receipt system, the electric receipt system comprising a point-of-sales terminal that generates electric receipt data, and an electric receipt management server that sends the electric receipt data to a portable terminal, the method comprising:
generating, in response to an input of a commodity code for specifying a commodity to return after sending the electric receipt data, corrected electric receipt data containing commodities included in the electric receipt data except for a commodity with the commodity code;
sending the corrected electric receipt data;
generating, in response to an input of a commodity code for specifying a commodity to return after sending the electric receipt data, returned-commodity receipt data according to the commodity code;
printing a return receipt on the basis of the returned-commodity receipt data, the return receipt indicating a returned commodity;
receiving the corrected electric receipt data; and
sending the corrected electric receipt data to the portable terminal.

6. The management method according to claim 5, further comprising
printing the returned-commodity receipt data to which information representing the retuned commodity is added.

7. The management method according to claim 5, further comprising:
generating electric returned-commodity receipt data on the basis of the returned-commodity receipt data;
sending the electric returned-commodity receipt data;
receiving the electric returned-commodity receipt data; and
sending the electric returned-commodity receipt data to the portable terminal.

8. The management method according to claim 5, further comprising:
generating, in response to an input of a commodity code for specifying a commodity to return after sending the electric receipt data to an external device, corrected receipt data excluding a commodity with the commodity code, and
generating electric corrected receipt data from the corrected receipt data when the corrected receipt data contains customer specification information for specifying a customer.
